(19) United States
(12) Patent Application Publication
(10) Pub. No.: US 2003/0003273 A1
(43) Pub. Date: Jan. 2, 2003

(54) Image receiving sheet

(75) Inventors: Akira Izutani, Osaka (JP); Masashi Yamamoto, Osaka (JP); Hiroshi Mizuno, Ikoma-Shi (JP); Masaharu Kanazawa, Osaka (JP); Masahiro Honda, Osaka (JP); Keyaki Yogome, Kyoto-Shi (JP)

Correspondence Address: MCDERMOTT, WILL & EMERY, 600 13th Street, N.W., WASHINGTON, DC, 20005-3096, US

(73) Assignee: Minolta Co., Ltd.

(21) Appl. No.: 10/159,259

(22) Filed: Jun. 3, 2002

(30) Foreign Application Priority Data
Jun. 5, 2001 (JP) 2001-169825
Jun. 5, 2001 (JP) 2001-169955

(51) Int. Cl. B32B 3/30

(52) U.S. Cl. 428/168; 428/167; 428/173

(57) ABSTRACT

Disclosed is an image receiving sheet for forming a toner image by removably adhering toner thereto.

The sheet has an irregular surface including a plurality of concavities in the form of continuous grooves for receiving the toner and ridges extending along the concavities, and a toner image can be formed by removably adhering the toner to the concavities. The ridges of the irregular surface are capable of protecting the toner adhering to the concavities. The continuously grooved concavities have a depth (height of ridges) of 20 μm to 150 μm; and a condition of E·A≧2 [GPa·μm] can be established wherein E[GPa] means Young's modulus and A [μm] means a width of ridges, the Young's modulus being a value when a material for forming the concavities and ridges is elongated by 1%. The ridges may be reinforced by reinforcing portions for retaining postures of the ridges.

### CROSS-REFERENCE TO RELATED APPLICATION

This application is based on Japanese Patent Applications No.2001-169825 and No. 2001-169955 both filed in Japan on Jun. 5, 2001, the entire contents of which are hereby incorporated by reference.

### BACKGROUND OF THE INVENTION

1. Field of the Invention

The present invention relates to an image receiving sheet for forming non-fixed images on which a toner image can be removably formed without being fixed thereto.

2. Description of Related Art

Image forming methods for forming a toner image on an image receiving sheet are known for long.

A typical example is an electrophotographic image forming method.

According to the electrophotographic image forming method, an electrostatic latent image carrier such as a photosensitive member is charged to a predetermined potential, and image exposure is effected in the charged region of electrostatic latent image carrier to form an electrostatic latent image on the carrier according to the original image information. Then the electrostatic latent image is developed into a visible toner image by a developer. The visible toner image on the electrostatic latent image carrier is transferred onto an image receiving sheet and is fixed thereto.

Other proposed image forming methods include a method in which toner is directly adhered to an image receiving sheet in accordance with the original image information, whereby a toner image is formed and fixed thereto, and a method in which a toner image is directly formed on an intermediate transfer member in a similar manner, is transferred to an image receiving sheet and is fixed thereto.

In any case, the toner fixed to an image receiving sheet can not be easily separated from the image receiving sheet, and therefore reuse of the toner and image receiving sheet is difficult. Thus nowadays, image receiving sheets having the toner images fixed thereto are cast away if they become unnecessary.

However, with the spread of computerization, large amounts of toner and image receiving sheets are consumed, and the energy required for the production of them as well as a carbon dioxide gas discharged thereby have been increasing.

A deinking method using an aqueous solution of a surface active agent is known for separating the toner from the image receiving sheet to reuse the image receiving sheets having the toner images fixed thereto. However, the deinking method needs a large quantity of energy for removing the water penetrated into image receiving sheets such as paper.

In view of the above, Japanese Unexamined Patent Publication No.2000-250249 proposed an image forming method of a non-fixing type for forming a toner image on an image receiving sheet, and an image receiving sheet to be used for implementing such method. The proposed image receiving sheet has an irregular surface including concavities for receiving the toner, and ridges for protecting the toner adhering to the concavities. A toner image is formed as the desired image on the irregular surface of the image receiving sheet by removably adhering the toner to the concavities.

According to the above-proposed image forming method of a non-fixing type and the image receiving sheet, a toner image is formed and retained such that the toner can be separated and removed from the image receiving sheet without being fixed thereto as conventionally done. Thus the toner and/or the image receiving sheet can be reused by separating the toner from the image receiving sheet having the toner image formed thereon.

However, the image receiving sheet disclosed in Japanese Unexamined Patent Publication No.2000-250249 posed problems. If the ridges for protecting the toner adhering to the concavities have insufficient strength, the ridges would be likely to easily fall or collapse by external force exerted on the sheet, thereby becoming unable to satisfactorily protect the toner.

If the ridges are feeble, the toner on the image receiving sheet would stick to our finger or the like. Further, when the image receiving sheets having the toner image formed thereon are discharged by a discharge roller, the ridges would fall or deform to an exceeding extent, thereby causing damage to images.

Feeble ridges raised other problems. For example, when the image receiving sheets are pulled out and fed, one by one, by a sheet-feeding device from a supply cassette accommodating the sheets as piled up, the sheet-feeding device exerts a strong action on the ridges, thereby collapsing the ridges and causing damage to them. In this case, it is difficult to form a good toner image on the image receiving sheet.

### SUMMARY OF THE INVENTION

An object of the present invention is to provide an image receiving sheet having the following features: an image can be formed on the image receiving sheet by removably retaining a toner image without being fixed thereto as conventionally done; the retained toner can be separated and removed from the sheet for reuse of the toner and/or the sheet; the toner image can be appropriately formed; and the formed toner image can be properly retained on the sheet.

The present invention provides three types of image receiving sheets as described below.

(1) First Type Image Receiving Sheet

The first type image receiving sheet is a sheet for forming a toner image by removably adhering toner thereto. The sheet has an irregular surface including a plurality of concavities in the form of continuous grooves which are capable of receiving the toner and ridges for protecting the toner adhering to the concavities. The toner image is formed by removably adhering the toner to the concavities.

The continuously grooved concavities have a depth (height of ridges) of 20 μm to 150 μm. The condition of E·A≧2 [GPa·μm] can be established wherein E[GPa] means Young's modulus and A [μm] means a width of ridges. The above-mentioned Young's modulus is a Young's modulus given when a material for forming the concavities and ridges is elongated by 1%.

(2) Second Type Image Receiving Sheet

The second type image receiving sheet is a sheet for forming a toner image by removably adhering toner thereto. The sheet has an irregular surface including a plurality of concavities in the form of continuous grooves which are capable of receiving the toner and ridges for protecting the toner adhering to the concavities. The toner image is formed by removably adhering the toner to the concavities.

The image receiving sheet has a margin portion which does not include the concavities and ridges. The margin portion is present at least in a portion of a peripheral area of the sheet surface having the irregular surface.

(3) Third Type Image Receiving Sheet

The third type image receiving sheet is a sheet for forming a toner image by removably adhering toner thereto. The sheet has an irregular surface including a plurality of concavities in the form of continuous grooves which are capable of receiving the toner and ridges for protecting the toner adhering to the concavities. The toner image is formed by removably adhering the toner to the concavities.

At least one of the ridges is reinforced by a reinforcing portion for keeping a posture of the ridge.

It is possible to employ a combination of two or more of the features of the three types of image receiving sheets.

The invention also provides methods for producing such image receiving sheets.

The foregoing and other objects, features, aspects and advantages of the present invention will become more apparent from the following detailed description of the present invention and the accompanying drawings.

### BRIEF DESCRIPTION OF THE DRAWINGS

FIG. 1(A) is a plan view of an example of the image receiving sheet, and FIG. 1(B) is an enlarged section view of a portion of the image receiving sheet.

FIG. 2 is a plan view of another example of the image receiving sheet.

FIG. 3 is a plan view of a further example of the image receiving sheet.

FIG. 4 is a plan view of an example of the image receiving sheet having a margin portion.

FIG. 5(A) and FIG. 5(B) schematically show an example of a method for producing the image receiving sheet.

FIG. 6 schematically shows another example of the method for producing the image receiving sheet.

FIG. 7(A) and FIG. 7(B) schematically show a further example of the method for producing the image receiving sheet.

FIG. 8(A) to FIG. 8(B) schematically show a still further example of the method for producing the image receiving sheet.

FIG. 9 schematically shows an additional example of the method for producing the image receiving sheet.

FIG. 10(A) and FIG. 10(B) schematically show another example of the method for producing the image receiving sheet.

FIG. 11 shows a schematic structure of an example of an image forming apparatus for forming a non-fixed image on the image receiving sheet.

FIG. 12(A) is a perspective view showing a portion of another example of the image receiving sheet. FIG. 12(B) is an enlarged section view of a portion of the image receiving sheet.

FIG. 13(A) is a perspective view showing a portion of a further example of the image receiving sheet. FIG. 13(B) is an enlarged section view of a portion of the image receiving sheet.

FIG. 14(A) is a perspective view showing a portion of a still further example of the image receiving sheet. FIG. 14(B) is an enlarged section view of a portion of the image receiving sheet.

FIG. 15(A) is a perspective view showing a portion of an additional example of the image receiving sheet. FIG. 15(B) is an enlarged section view of a portion of the image receiving sheet. FIG. 15(C) is a plan view of a portion of the sheet.

FIG. 16(A) is a perspective view showing a portion of another example of the image receiving sheet. FIG. 16(B) is an enlarged section view of a portion of the image receiving sheet. FIG. 16(C) is a plan view of a portion of the sheet.

### DESCRIPTION OF THE PREFERRED EMBODIMENTS

Preferred embodiments of the image receiving sheets of the invention will be described below.

The image receiving sheets to be described below are those for forming a toner image basically by removably adhering toner, the sheet having an irregular surface including a large number of concavities in the form of continuous grooves for receiving the toner and ridges capable of protecting the toner adhering to the concavities. A toner image can be formed by removably adhering the toner to the concavities.

(1) First Type Image Receiving Sheet and Second Type Image Receiving Sheet

In the first type image receiving sheet, the continuously grooved concavities have a depth (height of ridges) of 20 μm to 150 μm; and a condition of E·A≧2 [GPa·μm] can be established wherein E[GPa] means Young's modulus and A [μm] means a width of ridges. Young's modulus is a value given when a material for forming the concavities and ridges is elongated by 1%.

Since the continuously grooved concavities have a depth (height of ridges) of 20 μm to 150 μm, the toner can be properly adhered to the concavities in forming a toner image and the toner adhering thereto can be protected by the ridges. The ridges of the image receiving sheet are formed along the concavities to provide the grooved concavities therewith.

Because the material for forming the concavities and ridges of the image receiving sheet fulfill the condition of E·A≧2 [GPa·μm], the ridges on the sheet would be unlikely to fall or deform to an exceeding extent when handled as usual with our fingers. In view of these features, a toner image can be properly formed and the toner image thus formed can be suitably retained.

If the depth of the continuously grooved concavities (height of ridges) is excessively small, the adhered toner is liable to peel off, whereas if the depth thereof is excessively large, it is difficult to adhere the toner to the concavities in forming images. Accordingly the depth may be preferably about 25 μm to about 150 μm, more preferably about 50 μm to about 100 μm.

Materials for forming the ridges and concavities are, for example, thermoplastic resins and/or curable resins which are curable by specified treatment (these curable resins are curable by heat, light, electron rays or the like).

Examples of the thermoplastic resin are polyethylene, polypropylene, polystyrene, polycarbonate, polyethylene terephthalate and so on. These resins can be used either alone or in combination.

Examples of the thermosetting resin are epoxy resins, phenolic resins, melamine resins, unsaturated polyester resins and so on.

Examples of the photo-curable resin are acrylic resins, epoxy resins, ene-thiol resins, etc. Examples of the acryl oligomer are polyol-modified (meth)acrylate, polyether-modified (meth)acrylate, polyester-modified acrylate, polyurethane-modified (meth)acrylate, epoxy-modified (meth)acrylate, polyacetal-modified (meth)acrylate and the like.

Examples of the photopolymerization initiator to be used in employing a photo-curable resin are hydrogen-drawn polymerization initiators (benzophenone, camphorquinone and the like), photo-cleavage type initiators (benzoinethyl ether, 2,4,6-trimethylbenzoyl diphenylphosphone oxide and the like) and so on. Dimethylaminoethyl methacrylate, n-butylamine, triethylamine, isoamyl ester of 4-dimethylaminobenzoic acid and the like can be used as a sensitizer.

Electron rays-curable resins to be used include, for example, epoxy-modified acrylate, polyurethane-modified acrylate, acryl-modified polyester, etc.

Typical examples of preferable curable resins include epoxy resins which can be selected from a wide range without limitation on the molecule structure, molecular weight and the like insofar as it is a compound having at least two epoxy groups per molecule. Examples of the epoxy resin include epoxy novolak type, biphenyl type and like aromatic type, alicyclic type (such as cyclohexane derivatives), bisphenol A type and bisphenol F type.

Materials for forming concavities and ridges may include, for example, biodegradable resins which are degraded on contact with water or bacteria when buried in the soil.

Examples of useful biodegradable resins are chemosynthetic resins, microorganism-producing resins and natural resins. Among them, it is preferred to use natural resins having a chemical structure like that of the raw material for paper.

Materials for forming concavities and ridges may include, for example, polymers which are disolved in a solvent and solidified on vaporization of the solvent.

Examples of such polymers solidifiable on vaporization of a solvent are epoxy resins, acrylic resins, urethane resins, urethane-urea resins, cellulose derivatives and the like. These polymers can be used either alone or in combination. A curing agent may be added to these resins.

Materials for forming concavities and ridges may include, for example, materials containing at least one kind of fillers. The addition of fillers to the polymer resin upgrades the properties of polymer resin due to the filler. The filler is incorporated into the material for forming concavities and ridges preferably in an amount of about 0.5 wt. % to about 50 wt. %. The filler may be substantially uniformly dispersed in the material for forming concavities and ridges or may be allowed to exist locally in the close vicinity of the surface of ridges and concavities.

Useful fillers are, for example, inorganic particles and/or organic particles.

Useful fillers may be reinforced fibers.

The filler to be used may be finely devided and/or finely fibrous cellulose or polymer particles.

Inorganic fillers include, for example, calcium carbonate, barium carbonate, calcium sulfate, barium sulfate, magnesium hydroxide, magnesium oxide, titanium oxide, silica, talc, carbon black, etc.

Examples of the reinforced fibers are glass fibers, aramide fibers, carbon fibers, ceramic fibers, boron fibers, alumina fibers, silicon carbide fibers, etc. Reinforced fibers may be any of twisted fibers, unravelled twines, non-twisted fibers and the like. Because of high strength and durability, carbon fibers are preferred. Useful surface-treated fibers include glass fibers, aramide fibers, boron fibers, alumina fibers, silicon carbide fibers, etc. which are all surface-treated.

These fibers can be used either alone or in combination. At any rate, the filler may be subjected to surface-modifying treatment such as silane-coupling treatment, titanate-coupling treatment or the like to increase the affinity for polymers.

At least one kind of additives such as antistatic agents, stabilizers and surface tension adjusting agents and the like may be added to the polymer or like materials for forming concavities and ridges. The additives or like materials may be, for example, dispersed uniformly in the material. The antistatic agents, stabilizers and surface tension adjusting agents may be applied to the irregular surface after formation of irregular surface with the material such as polymers.

The image receiving sheet may comprise a sheet substrate layer (base layer) on which a layer composed of a material for forming the concavities. and ridges is formed.

The substrate layer (base layer) may be formed, for example, of paper or films. Examples of paper are wood-free plain paper, regenerated paper, recycled paper or RC paper coated with polyethylene or like resins which have a basis weight of about 25 g/m² to about 250 g/m². Useful films are, for example, polyethylene films, polypropylene films, polyethylene terephthalate films and the like.

The image receiving sheet may have a margin portion which does not include concavities and ridges. The margin portion is at least a portion of a peripheral area of the sheet surface having the irregular surface. The image receiving sheet having such a margin portion is the second type image receiving sheet of the invention.

The image receiving sheet having the margin portion can be handled without contact with the irregular surface of the sheet by using the margin portion, whereby images can be properly formed while suppressing the damage to the ridges. Further advantageously, the image receiving sheet having a toner image can be suppressed from damage to the toner image and from sticking of toner to our fingers.

It is preferred to form the margin portion at least in a region of the sheet wherein a sheet-feeding device will act on the sheet when the image receiving sheet is sent out by the sheet-feeding device from a stack of the accumulated image receiving sheets.

The image receiving sheets described hereinbefore can be produced, for example, by the following methods.

1. A method wherein a resin melt is forced out onto a sheet substrate for forming a substrate layer, and then a roller having an irregular surface pattern on the surface is rotated relatively to move over the resin on the surface of the substrate, whereby a layer having an irregular surface of resin is formed on the surface of the substrate.

2. A method wherein a roller having an irregular surface pattern on the surface is pre-heated and is rotated relatively to move on a sheet of material for forming an image receiving sheet, whereby an irregular surface is formed on the surface of the sheet.

3. A method wherein a sheet having a curable resin layer on its surface is used, and an irregular surface is formed on the curable resin layer, which is cured by a specified method.

The curable resin can be cured by application of, e.g., heat, light rays or electron rays according to the kind of the resin. A resin of the type which is cured by drying on vaporization of a solvent may be used.

4. A method wherein a melt of resin is forced out onto a sheet substrate through a nozzle having an orifice having an irregular pattern to form an irregular surface on the sheet substrate.

5. A method wherein an impressing block having an irregular surface pattern is laid on a sheet of material for forming an image receiving sheet, which is heated and pressed by a hot press to form an irregular surface on the sheet in a pattern defined reversely to the pattern on the impressing block wherein the concavities and ridges are replaced with each other.

When the irregular surface is formed by an impressing block (impressing roller) as done in the methods 1 and 2, the irregular surface may be formed by pressing a roller having an irregular surface pattern against an opposite roller as opposed to the roller having the irregular surface pattern so as to form a sheet surface curved along the opposite roller. In the method 5, the surface of the impressing block may be so contoured at a specified curvature that the irregular surface is inwardly curved. Thereby the obtained image receiving sheet can be suppressed from curling. The other side than the irregular surface of the sheet may be coated with a resin, fine particles or the like to prevent the sheet from curling. The curling degree is suppressed more by performing both of the above-mentioned preventive measures.

Any image forming method may be implemented insofar as the method is capable of forming concavities and ridges with the predetermined width, pitch and depth (height).

Non-fixed images can be formed on the thus-obtained image receiving sheet, for example, by the following methods.

An image forming apparatus to be used is, for example, one having a photosensitive member which is surrounded with a charger, an exposing device, a developing device, a transfer device, a cleaning device and a discharger which are disposed in this order.

A ridge toner-removing device for removing the toner adhering to the ridges of the sheet is also disposed downstream in the sheet feed direction.

The surface of the photosensitive member having a photoconductive layer is uniformly charged by the charger, and is exposed according to an original image information by the exposing device to form an electrostatic latent image on the photosensitive member. Thereafter toner particles (e.g., negative polarity) are adhered to the photosensitive member according to the electrostatic latent image by the developing device.

The toner particles are transferred by the transfer device to the image receiving sheet transported thereto.

A major portion of the toner particles transferred to the image receiving sheet is allowed to adhere to the concavities of the irregular surface of the image receiving sheet, while a minor portion thereof is allowed to adhere to the ridges thereof. The image receiving sheet having the toner image transferred thereto is transported to the ridge toner-removing device (ridge-cleaning device) where the toner particles adhering to the ridges are removed by a cleaning member to form a desired image.

The toner remaining on the photosensitive member is removed by the cleaning device and the photosensitive member is electrically discharged by the discharger.

The image forming apparatus forming an image on the image receiving sheet may be combined with an image forming apparatus employing an electrophotograhic method to provide an image forming apparatus of the hybrid type. Since some parts can be used commonly by the two apparatuses, the apparatus of the hybrid type can be advantageously manufactured at a lower cost and in an compact arrangement.

The image forming apparatus of the hybrid type may be made by providing the electrophotographic image forming apparatus with a write head to be specifically used in image forming on the image receiving sheet of the non-fixed type.

It is also possible to use an image carrier having a dielectric layer instead of the photosensitive member. In this case, an electrostatic latent image may be formed by an ion flow-multistylus method, and the latent image may be developed by toner particles and transferred to the image receiving sheet to form an image thereon.

Toner particles may be selectively adhered directly to the image receiving sheet to thereby form an image(toner jet method).

An electrostatic latent image may be formed directly on the image receiving sheet by e.g., an ion flow-multistylus method, and may be developed by a developer to form an image on the image receiving sheet.

According to the image receiving sheet described above, the following features can be provided. Images can be formed on the image receiving sheet by removably retaining the toner thereon without being fixed thereto as done conventionally. Accordingly the image receiving sheet can be reused by separating and removing the retained toner. Moreover, a toner image can be properly formed on the image receiving sheet and can be retained in an appropriate manner.

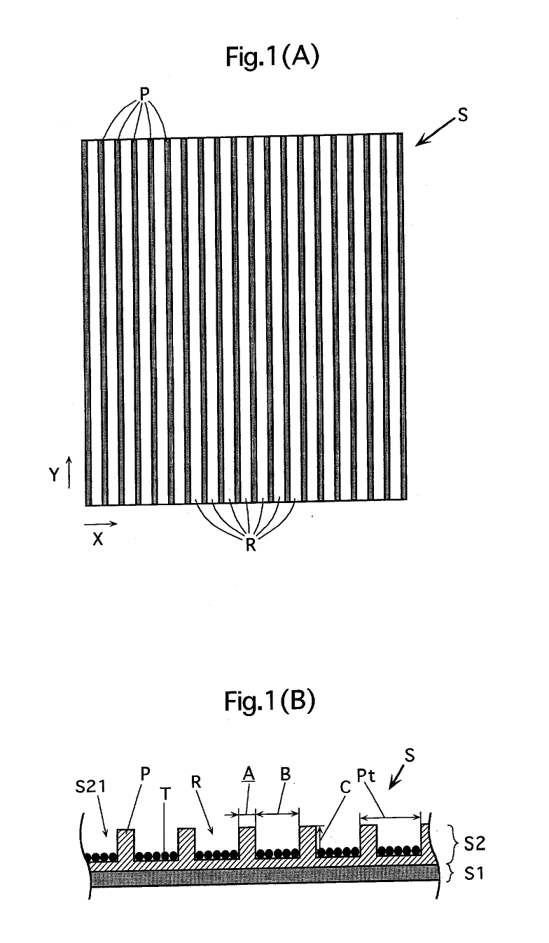

Examples of the first type image receiving sheet will be described with reference to FIG. 1(A) to FIG. 3.

FIG. 1(A) and FIG. 1(B) are a plan view of an example of the image receiving sheet, and an enlarged section view of a portion of the image receiving sheet, respectively.

As shown in FIG. 1(B), an image receiving sheet S comprises a sheet substrate S1 made of paper and an image receiving layer S2 formed of a synthetic resin on one surface of the sheet substrate S1. The image receiving sheet is white in its entirety. The letter T in FIG. 1(B) represents the toner depicted in an enlarged size.

The image receiving layer S2 includes concavities (continuously grooved concavities in this embodiment) R for accommodating toner T and ridges (ridge portions in this embodiment) P for protecting the toner T accommodated in the concavities. In the image receiving sheet S, the concavities R and ridges P of the image receiving layer S2 are formed in parallel with a sheet feed direction Y (see FIG. 1(A)). The ridges P provide the concavities R and extend along the concavities R. The sheet feed direction Y is a direction in which the image receiving sheet S is transported in forming images on the image receiving sheet S to be described later.

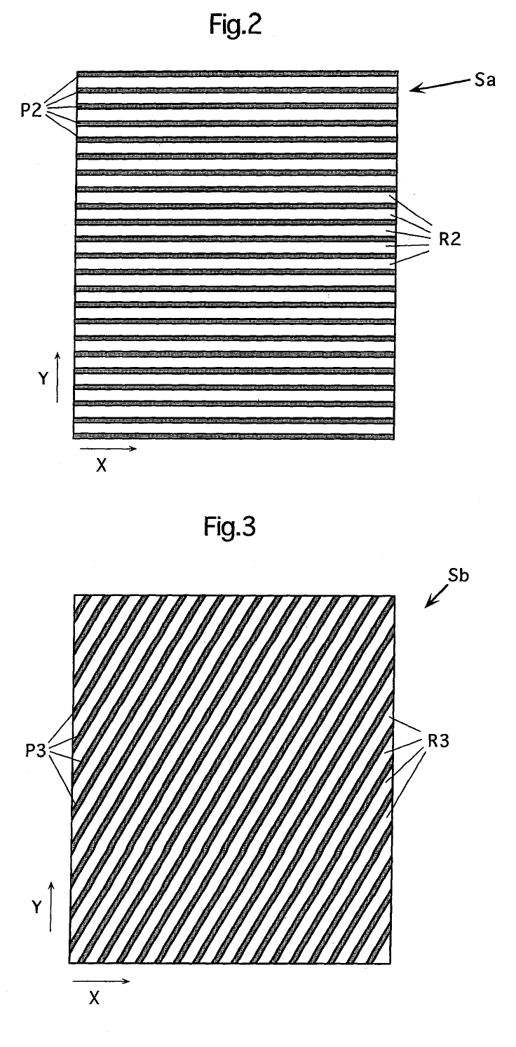

The continuously grooved concavities and the ridges are not limited to the above embodiment. For example, an image receiving sheet Sa may be provided as shown in FIG. 2 such that the continuously grooved concavities R2 and the ridges P2 are formed in parallel with a direction X orthogonal to the sheet feed direction Y. Optionally an image receiving sheet Sb may be provided as shown in FIG. 3 such that the continuously grooved concavities R3 and the ridges P3 are formed in a direction at an angle inclined with respect to the sheet feed direction Y. In any case, the concavities R (R2, R3) are formed in the form of continuous grooves and ridges P (P2, P3) are formed along the concavities (R2, R3). The continuously grooved concavities may be provided with transverse ridges or projections between neighboring ridges at a suitable spacing to reinforce the ridges, when so required.

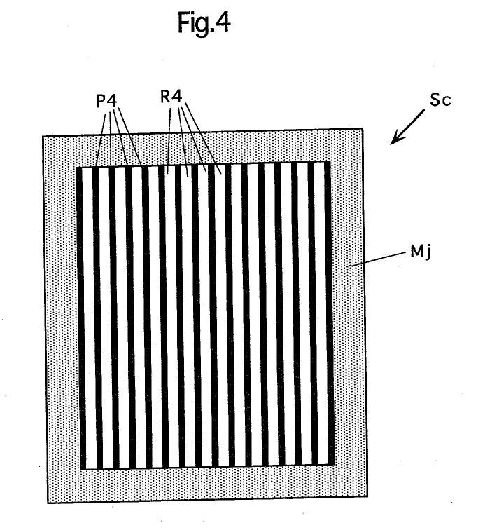

An image receiving sheet Sc may be provided as shown in FIG. 4 in which a margin portion Mj without concavities and ridges is formed in a peripheral area of the sheet. The margin portion Mj of the image receiving sheet Sc is formed at least in a region of the sheet wherein the image receiving sheet is actively handled at least by a feed roller of the image forming apparatus to be described later or by a sheet-feeding device for supplying the image receiving sheets, one by one, from a sheet supply tray. In this structure, the undesirable disturbance of images and collapse of ridges can be suppressed to allow suitable formation of images. The margin portion Mj may be provided not in the entire peripheral area of the sheet but only in a limited portion of the peripheral area.

In the image receiving sheet S, the width B of concavities R in the image receiving layer S2 is about 15 μm to about 400 μm; the width A of ridges P is about 5 μm to about 100 μm; and the depth C of concavities R (height of the ridges P) is about 20 μm to about 150 μm. The width A of ridges P is in the range of ⅔ to 1/50 the width B of concavities R.

The image receiving sheet S has the concavities R and ridges P uniformly located thereon. The total area occupied by the concavities R in the irregular surface S21 of image receiving layer S2 is greater than the total area occupied by the ridges P, and the concavities R have a depth and a width exceeding the average particle size of toner particles to be described later and are capable of receiving a plurality of toner particles therein.

The illustrated image receiving sheet S is a two-layer laminate sheet having the image receiving layer S2 over the sheet substrate S1. Optionally the sheet S may be a laminate composed of more than two layers or may be a sheet consisting of a single layer.

This embodiment of image receiving sheet has a white color although not limited thereto and may have other colors according to the color of the toner.

The image receiving layer S2 may be formed of a material (material for forming concavities and ridges) such as thermoplastic resins and/or curable resins which are curable by a specified treatment.

The image receiving layer S2 may be formed of a material such as the above-mentioned biodegradable resins which are degradable by contact with water or bacteria when buried in the soil.

The image receiving layer S2 may be formed of a material such as the above-mentioned polymer of the type which is solidified on vaporization of a solvent.

In any case, at least one of the above-mentioned fillers may be incorporated in a proportion of 0.5 wt % to 50 wt % into the material for forming the image receiving layer S2.

The filler may be subjected to surface-modifying treatment such as silane-coupling treatment, titanate-coupling treatment or the like.

The material for forming the image receiving layer S2 may contain at least one kind of additives such as antistatic agents, stabilizers and surface tension adjusting agents.

These additives may be applied to the irregular surface after formation of the irregular surface.

The image receiving sheet S may comprise the sheet substrate S1 and the image receiving layer S2 lying on the sheet substrate S1, the layer S2 being composed of a material for forming the concavities and ridges.

The sheet substrate S1 may be composed of paper or film having a basis weight of about 25 g/m² to about 250 g/m². Useful films are, for example, polyethylene films, polypropylene films, polyethylene terephthalate films and the like.

Methods for producing an image receiving sheet will be described in more detail with reference to drawings.

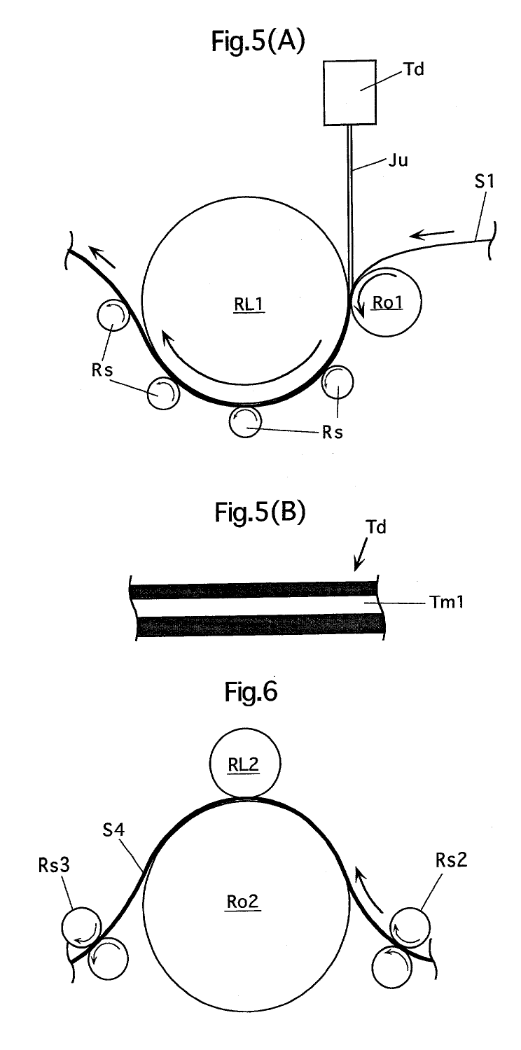

FIG. 5(A) and FIG. 5(B) schematically show an example of the method for producing an image receiving sheet.

The method for producing an image receiving sheet which is shown in FIG. 5(A) and FIG. 5(B) employs a molding roller RL1 having an irregular surface pattern on the surface; a pressing roller Ro1 opposed to the molding roller RL1; and a T-die Td having an injection orifice (injection nozzle) Tm1 shown in FIG. 5(B) for injecting molten thermosetting resin Ju onto the sheet substrate S1 passing between the molding roller RL1 and the pressing roller Ro1.

A film of molten thermosetting resin Ju is forced out from the T-die Td onto the surface of the sheet substrate S1 transported to the pressing roller Ro1 by a supply device (not shown) to form a laminate sheet comprising the sheet substrate and a thermosetting resin layer. Thereafter, the laminate sheet is pressed between the molding roller RL1 and the pressing roller Ro1 to impress an irregular surface pattern which is reverse in positions of concavities and ridges to the embossed irregular surface pattern on the surface of the molding roller RL1. The thermosetting resin layer of the image receiving sheet S having the irregular surface formed thereon is cured and is discharged by a feed roller Rs.

FIG. 6 schematically shows another example of the method for producing an image receiving sheet.

The method for producing an image receiving sheet which is shown in FIG. 6 uses (i) a heat-molding roller RL2 having an irregular surface pattern on the surface and capable of heating a sheet and (ii) a pressing roller Ro2 capable of pressing the passing sheet against the roller RL2 to form concavities and ridges on the sheet.

First, a sheet S4 having a thermoplastic resin layer on a sheet substrate is fed by paired sheet feed rollers Rs2 in such a way that the resin layer faces the side of heat-molding roller RL2. Thereby the sheet S4 is supplied between the roller RL2 and the roller Ro2. While passing between the two rollers, the sheet S4 is heated and pressed, whereby an irregular surface pattern is impressed on the resin layer, and the sheet S4 is discharged by a pair of discharge rollers Rs3.

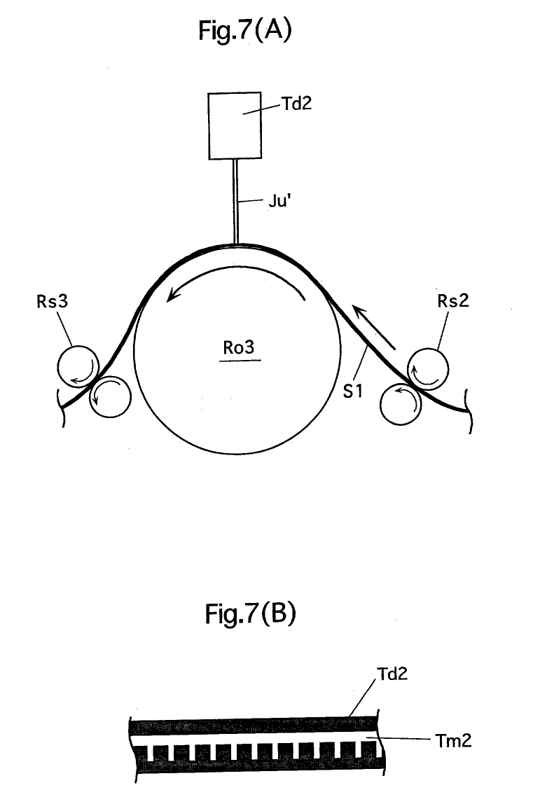

FIG. 7(A) and FIG. 7(B) schematically show a further example of the method for producing an image receiving sheet.

The method for producing an image receiving sheet which is shown in FIG. 7(A) and FIG. 7(B) employs a cooling roller Ro3 for cooling the sheet and. a T-die Td2 for injecting a molten resin. An injection orifice Tm2 of the T-die Td2 is internally defined to give an irregular surface pattern which complies with the concavities and ridges of an image receiving sheet to be produced as shown in FIG. 7(B).

First, a sheet substrate S1 is fed by a pair of feed rollers Rs2 to the cooling roller Ro3. Thereafter, the sheet substrate S1 ascends an upper portion of the roller Ro3 along the roller Ro3, and a molten resin Ju′ injected from the T-die Td2 is allowed to continuously adhere to the surface of sheet substrate S1 on reaching the highest point of the roller Ro3. Then, the resin layer is cured and the completed image receiving sheet is discharged by a pair of discharge rollers Rs3.

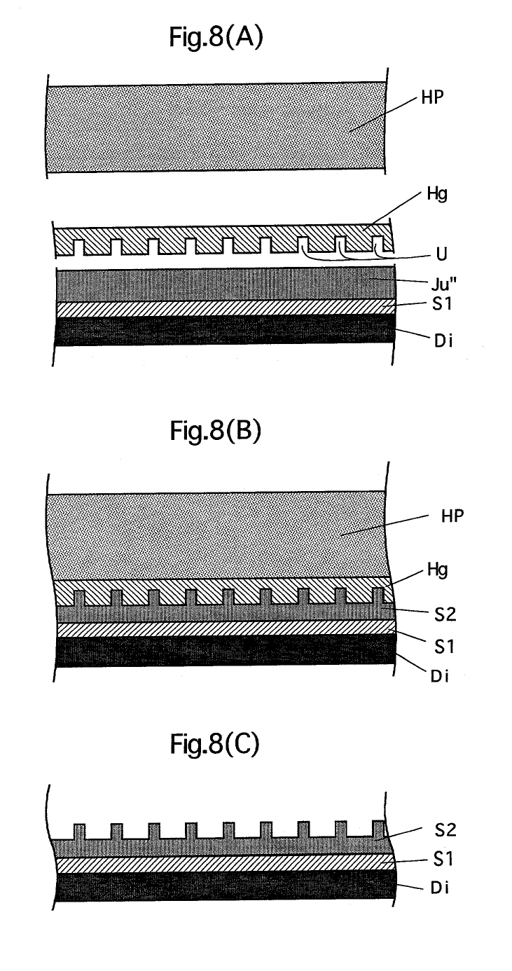

FIG. 8(A) to FIG. 8(C) schematically show a still further example of the method for producing an image receiving sheet.

The method for producing an image receiving sheet which is shown in FIG. 8(A) to FIG. 8(C) employs an impressing block Hg having an irregular surface pattern which is reverse in positions of concavities and ridges to that of an image receiving sheet to be produced; and a hot press HP.

For example, the impressing block Hg is produced by forming continuously grooved concavities U on a silicone wafer by dicer processing (see FIG. 8(A)). A laminate sheet comprising a sheet substrate S1 and a resin Ju″ deposited on a sheet substrate S1 is placed on a base Di with the resin Ju″ facing up. The impressing block Hg is superimposed on the laminate sheet with the concavities U of the block facing the resin. Then, the laminate sheet is heated and pressed by a hot press placed on the impressing block Hg. An image receiving layer is formed by impressing an irregular surface pattern of the impressing block Hg on the layer of the resin Ju″ to form an irregular surface having concavities and ridges defined reversely to those in the irregular pattern of the block Hg (see FIG. 8(B)). The hot press HP and the impressing block HG are removed and the image receiving sheet S is taken out.

The impressing block may be formed of a material such as metal, which is unlikely to deform by heating or pressing, instead of the silicon wafer. An impressing block may be produced by forming continuously grooved concavities on a plate of metal by dicer processing and impressing the pattern on silicone rubber.

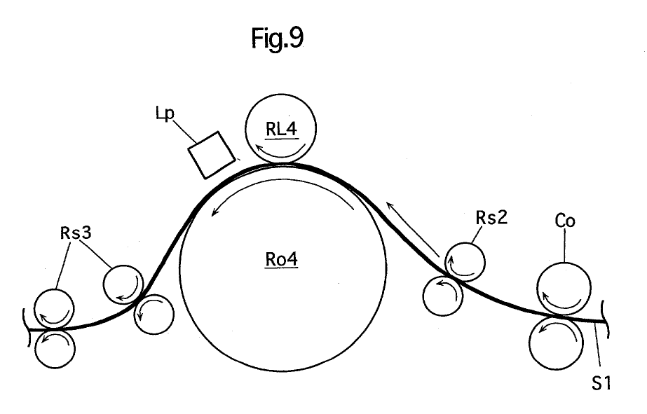

FIG. 9 schematically shows an additional example of the method for producing an image receiving sheet.

The method for producing an image receiving sheet which is shown in FIG. 9 employs a heat-molding roller RL4 having an irregular surface pattern on the surface; a resin coater Co for coating the surface of a sheet substrate S1 on the side of roller RL4 with a photocurable resin; a heating-pressing roller Ro4 for heating and pressing the sheet; and a light-irradiating device Lp for curing a layer of photocurable resin having an irregular surface.

First, one surface of the sheet substrate S1 is substantially uniformly coated by the coater Co with a photocurable resin, and is fed between the heating-pressing roller Ro4 and the heat-molding roller RL4 by a pair of feed roller Rs2. The side of the sheet substrate is heated and pressed by the roller Ro4, and concavities and ridges are formed on the surface of the resin layer by pressing the irregular surface of the roller RL4 against the surface of the resin layer while heating the side of the resin layer by the roller RL4. The resin layer having the irregular surface is irradiated with light rays by the light-irradiating device Lp to cure the resin layer, whereby an image receiving sheet is produced and is discharged by the paired discharge rollers Rs3.

The light rays to be emitted by the light-irradiating device Lp can be any of visible light, UV light and the like which can cure the resin. It is possible to use a resin which is curable by electron rays instead of photocurable resins. In this case, an electron rays-irradiating device is used.

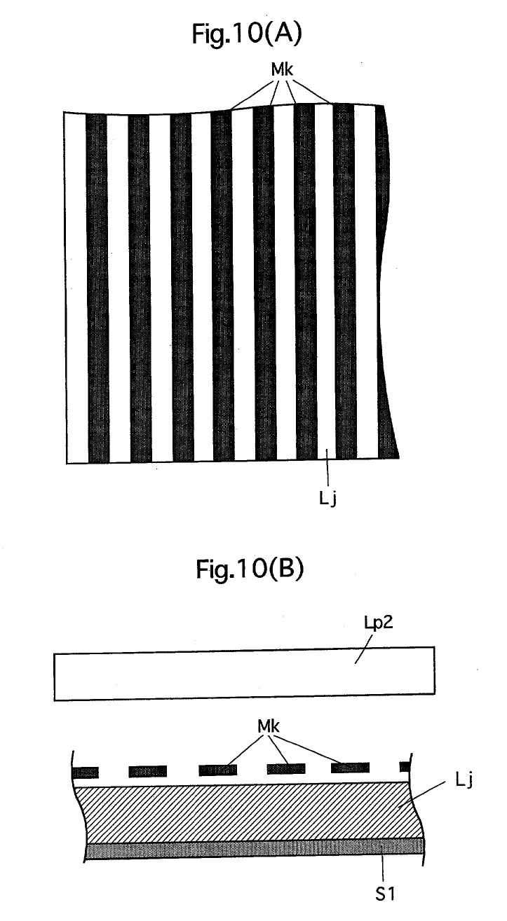

FIG. 10(A) and FIG. 10(B) schematically show another example of the method for producing an image receiving sheet.

The method for producing an image receiving sheet which is shown in FIG. 10(A) and FIG. 10(B) employs a light-irradiating device Lp2 for curing the photocurable resin; a light-intercepting mask Mk having a specified transparent pattern and capable of intercepting the light emitted from the light-irradiating device Lp2; and a cleaning device (not shown) for removing the undesired resin.

First, a layer Lj of photocurable resin is deposited on the surface of sheet substrate S1 (see FIG. 10(A)). The light-intercepting mask Mk is laid on the resin layer Lj to shield surface portions of the layer Lj for forming concavities from light emitted from the light-irradiating device Lp2. Light is shed from the side of the light-intercepting mask Mk by the light-irradiating device Lp2 to cure the surface portions of the resin layer Lj for forming the ridges. Thereafter the mask Mk is detached and the uncured resin is removed by the cleaning device (not shown) using a cleaning agent (such as water) to finish the image receiving sheet.

In the foregoing examples of methods for producing an image receiving sheet, it is possible to use biodegradable resins, resins curable on vaporization of a solvent or the like which are employable in the methods, although thermoplastic resins, thermosetting resins, photocurable resins and the like are mainly used.

The image receiving sheet having an irregular surface can be prevented from curling in the following manner. The impressing roller for forming an irregular surface may be pressed on the surface of the sheet as done in the above methods but such that the surface is curved along the roller opposed to the roller having the irregular surface pattern. Optionally the irregular surface of the impressing roller may be inwardly curved at a specified curvature.

The surface of the sheet which does not have the irregular surface may be coated with a resin or fine particles to suppress the curling of the sheet. If these two measures are both taken, a higher effect of preventing the curling of the sheet is achieved.

In the methods for producing an image receiving sheet, if necessary, a margin portion Mj (see FIG. 4) without an uneven surface may be arranged at least in a portion of a peripheral area of the image receiving sheet. When required, a filler may be incorporated into a resin material before deposition or injection of the resin on the sheet substrate.

In the foregoing methods for producing an image receiving sheet, a laminate sheet comprising a sheet substrate and a resin layer is used. The structure of the image receiving sheet is not limited to a 2-layer laminate. The image receiving sheet may be comprised of more than 2 layers or a single layer insofar as these methods permit the production of such image receiving sheet.

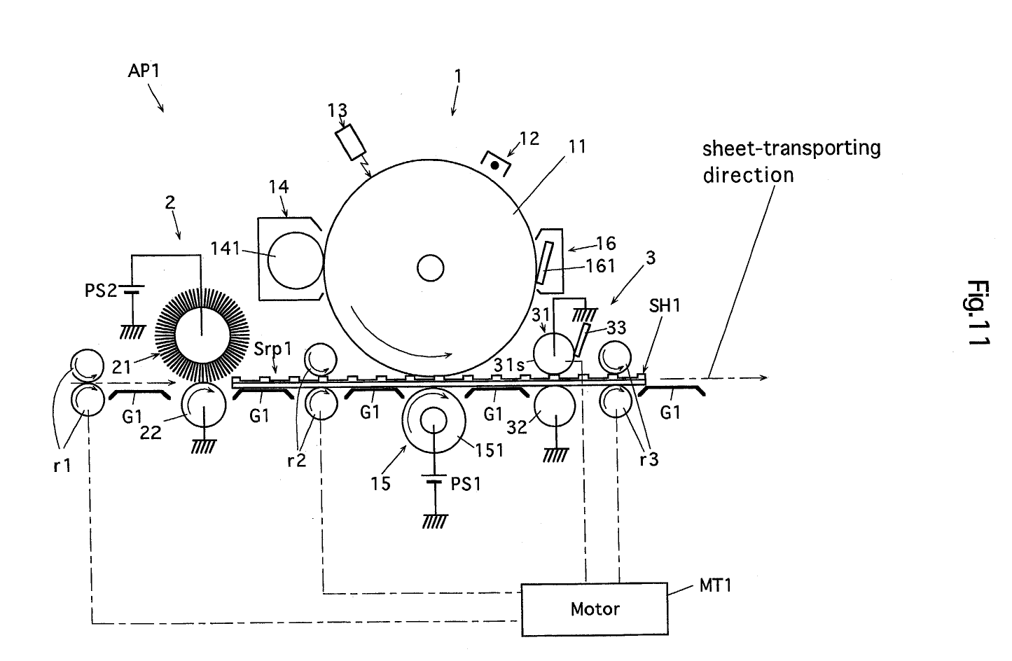

FIG. 11 shows a schematic structure of an example of an image forming apparatus for forming a non-fixed image on the image receiving sheet of the non-fixing type.

An image forming apparatus AP1 of FIG. 11 is provided with a ridge-cleaning device 3 for removing the toner adhering to the ridges of the irregular surface of the image receiving sheet.

The image forming apparatus AP1 is also provided with a toner image forming device 1 for forming a toner image on an image receiving sheet S and with a sheet-cleaning device 2 for removing the toner images formed on the image receiving sheet before forming images.

When an image is formed on the irregular surface of the image receiving sheet by the image forming apparatus AP1, the image receiving sheet is transported on a specified sheet-transporting path as guided by a guide member G1 or the like. The image receiving sheet is carried from, for example, a sheet tray (not shown) for accommodating a plurality of the image receiving sheets toward a discharge tray (not shown) for accommodating image receiving sheets having image(s) formed thereon while image(s) is(are) formed on running image receiving sheet.

The image receiving sheet is transported at a specified speed by pairs of rollers r1 to r3 provided in positions opposed to the sheet-transporting path. When image receiving sheet is transported, the pairs of rollers r1 to r3 are driven to rotate in a predetermined direction at a specified speed via a driving force transmitting mechanism such as a mechanism including a gear train and/or a belt (not shown) by a motor MT1 in the illustrated embodiment. A photosensitive member 11 and a transfer roller 15 are driven to rotate via a driving force transmitting mechanism (not shown) by the motor MT1 in this embodiment.

The image receiving sheet being carried at the predetermined sheet-transporting speed in this way is successively subjected to a cleaning processing by the sheet-cleaning device 2, subjected to a toner image forming processing by the toner image forming device 1, and subjected to a ridge-cleaning processing by the ridge-cleaning device 3 in this order. Description is given below about operations of devices in forming an image on the image receiving sheet S shown in FIG. 1.

The image receiving sheet S is subjected to the following cleaning processing by the sheet-cleaning device 2. The sheet-cleaning device 2 is adapted to remove the toner adhering to the concavities and ridges of the irregular surface of the image receiving sheet. Toner image(s) may be already formed on the irregular surface of the image receiving sheet. The toner image(s) is(are) removed from the irregular surface of the sheet, whereby the sheet is made ready for the formation of images by the toner image forming device 1.

The sheet-cleaning device 2 has an electrically conductive brush roller 21 connected to a power source PS2 and a grounded platen roller 22. The brush roller 21 is supplied with a bias voltage having a polarity opposite to the charged polarity (negative polarity in this embodiment) of toner T on the irregular surface S21 of the image receiving sheet S from a power source PS2. The toner T adhering to the ridges P and concavities R of the irregular surface S21 of the image receiving sheet S (mainly the toner adhering to the concavities R) can be removed by the electrostatic force derived from the bias voltage.

The charged toner on the image receiving sheet S can be easily removed by electrostatic force. The toner can be so easily removed because the toner forming the toner image is merely adhered to the irregular surface S21 of the image receiving sheet S without being fixed thereto. Because of this feature, the image receiving sheet S can be repeatedly reused for formation of images. The toner removed from the image receiving sheet S may be reused for formation of toner images by the toner image forming device 1.

After removal of the toner from the image receiving sheet S, a toner image is formed on the image receiving sheet by the toner image forming device 1.

The toner image forming device 1 can form a toner image on the image receiving sheet by electrophotographic method. The toner image forming device 1 has a photosensitive member 11 which is surrounded with a charger 12, an exposing device 13, a developing device 14, a transfer device 15 and a cleaning device 16.

When a toner image is formed on the image receiving sheet S, the surface of the photosensitive member 11 is uniformly charged by the charger 12 to a predetermined potential, i.e. about −900V in this embodiment. Then, the charged surface of the photosensitive member 11 is exposed according to an original image information by the exposing device 13 (laser device in this embodiment) to reduce the potential of the exposed surface portion of the photosensitive member 11. In this embodiment, the potential of the surface portion of the photosensitive member 11 irradiated with light rays is reduced to about −100V in this embodiment. Thereby an electrostatic latent image corresponding to the original image information is formed on the surface of the photosensitive member 11. A toner image corresponding to the original image information is formed on the photosensitive member 11 by developing the electrostatic latent image using the charged toner of the predetermined polarity (negatively charged toner in this embodiment) by the developing device 14. In the developing device 14, a developing bias voltage (about −350V in this embodiment) is applied to a developing roller 141 carrying the charged toner, whereby the electrostatic latent image is developed. The toner image formed on the photosensitive member 11 is transferred to the image receiving sheet S by the transfer device 15 having a transfer roller 151 opposed to the photosensitive member 11. In this operation, the transfer roller 151 is supplied with a transfer bias voltage having a polarity opposite to the charged polarity (negative polarity in this embodiment) of toner T on the photosensitive member 11. The toner image on the photosensitive member 11 is electrostatically transferred to the irregular surface S21 of the image receiving sheet S by the bias voltage. The toner remaining on the photosensitive member 11 without being transferred is removed from the photosensitive member 11 by a cleaning blade 161 of the cleaning device 16. The toner removed from the photosensitive member 11 may be reused for development (formation of toner image by the toner image forming device 1) by the developing device 14.

When a toner image is formed in this way on the irregular surface S21 of the image receiving sheet S, the toner image may be formed in positions corresponding to ridges of the irregular surface. In this case, the toner is allowed to adhere to the ridges. The toner adhering to ridges P is easily transferred to another object (our fingers, another image receiving sheet or the like) on contact of the sheet with the object and is liable to smear the object. To suppress this possibility, the toner adhering to the ridges is removed by the ridge-cleaning device 3.

The ridge-cleaning device 3 includes a cleaning roller 31 and a platen roller 32 both disposed in positions confronting the sheet-transporting path. These rollers 31, 32 are disposed in predetermined places. The rollers 31, 32 are both metallic rollers and are grounded in this embodiment. The image receiving sheet S is allowed to pass between the rollers 31, 32. During passage, the cleaning roller 31 is brought into contact with the tops of ridges P of the irregular surface S21 of the image receiving sheet S to thereby remove the toner from the ridges P of the image receiving sheet S.

In removing the toner adhering to the ridges P of the image receiving sheet S (in cleaning the ridges), the image receiving sheet S is fed at the predetermined sheet-transporting speed by a driving device including the motor MT1. Since the cleaning roller 31 is disposed in the predetermined place, the image receiving. sheet S is allowed to move at the predetermined sheet-transporting speed relatively to the cleaning roller 31. In addition, the irregular surface S21 including the ridges P of the image receiving sheet S is allowed to move at the predetermined surface-moving speed (=predetermined sheet-transporting speed) relatively to the cleaning roller 31.

When the ridges are cleaned, the cleaning roller 31 is driven to rotate in a predetermined direction at a predetermined speed. The cleaning roller 31 is driven to rotate by the motor MT1 via the driving force transmitting mechanism (not shown). Thereby the surface of the cleaning roller 31 in contact with the image receiving sheet is permitted to move in a predetermined direction at a predetermined surface-moving speed in cleaning the ridges.

The cleaning roller 31 may be driven to rotate either clockwise or counterclockwise in FIG. 11. More specifically, the cleaning roller 31 may be driven to rotate clockwise in FIG. 11, and the roller surface may be moved in a direction opposite to the sheet feed direction in a region in which the roller surface is held in contact with the image receiving sheet. Alternatively the cleaning roller 31 may be driven to rotate counterclockwise in FIG. 11, and the roller surface may be moved in the same direction as the sheet feed direction in a region wherein the roller surface is held in contact with the image receiving sheet. The platen roller 32 may be drivenly rotated, for example, according to the movement of the image receiving sheet.

The roller surface of the cleaning roller 31 which is driven to rotate in the predetermined direction as described above is brought into contact with the ridges P of the irregular surface S21 of the image receiving sheet S which is carried in the predetermined direction in a manner to rub the ridges P with the roller surface, whereby the toner T adhering to the ridges P is removed. The toner removed from the cleaning roller 31 may be reused for forming a toner image by the toner image forming device 1.

In the ridge-cleaning method and device, in any case of moving the surface of the cleaning roller in the same direction as the moving direction (i.e., the sheet feed direction in this embodiment) of the surface of the image receiving sheet or in an opposite direction, a difference of the speed is made between the moving speed of the surface (in contact with the image receiving sheet) of the cleaning roller 31 and the moving speed of the surface of the image receiving sheet. Typically the moving speed of the surface of the cleaning roller 31 is made greater than the moving speed of the surface of the image receiving sheet. In the image forming apparatus AP1, the difference of the speed between the moving speed of the surface of the cleaning roller 31 and the moving speed of the surface of the image receiving sheet can be achieved by adjusting the relationship between a speed reducing ratio in the driving force transmitting mechanism for supply of the force from the motor MT1 to the paired rollers r1 to r3 for transporting the image receiving sheet and a speed reducing ratio in the driving force transmitting mechanism for supply of the force from the motor MT1 to the cleaning roller 31 for rotationally driving the cleaning roller 31.

The difference of the speed achieved in this way permits removal of the toner from the ridges while suppressing the disturbance of toner image formed of the toner adhering to the concavities of the image receiving sheet.

In FIG. 11, the image receiving sheet S is transported in a direction perpendicular to the extending direction of ridges P. The image receiving sheet S may be optionally transported in the extending direction of ridges P. The ridges can be cleaned more properly when the image receiving sheet S is transported in the extending direction of ridges P than when the image receiving sheet S is transported in a direction perpendicular to the extending direction of ridges P.

While the toner constituting the toner image(s) is fitted in concavities R of the irregular surface S21 of the image receiving sheet, the toner image formed on the image receiving sheet S is protected by the ridges of the irregular surface. Consequently, unless an extraordinary external force is exerted, the toner image formed on the image receiving sheet can retain the required state of the toner image although the toner image formed thereon is merely adhered to the image receiving sheet without being fixed thereto by heating as done in conventional image forming methods. When looking at toner images on the image receiving sheet, or storing or merely moving the image receiving sheet, the image receiving sheets may be brought into contact with each other, or our finger may slightly touch the image receiving sheet. Such slight external force would be unlikely to cause undesirable incidents such as marked disturbance of toner images and adhesion of the toner to the rear side of overlaid image receiving sheet.

Moreover, merely the toner is removably adhered to the image receiving sheet and can be separated and removed therefrom so that the removed toner and the image receiving sheet without the toner can be reused.

Experiments for forming images on an image receiving sheet were carried out. Experimental Examples are as follows. Thirty four kinds of samples having ridges of different widths A (μm) and different heights C (μm), and concavities of different widths B (μm) were prepared from various materials for forming an irregular surface. Each sample was prepared by the following methods.

(Sample 1 to Sample 14)

Sample 1 to Sample 14 are image receiving sheets S of a non-fixing type formed of low density polyethylene.

First, impressing blocks for forming an irregular surface of the image receiving sheet were produced. Each of the impressing blocks was a silicon wafer on which a plurality of continuous grooves in a regular arrangement were formed by dicer processing. A plurality of impressing blocks were prepared for each sample. Each impressing block had a plurality of continuous grooves formed with a width of 5 μm to 100 μm, a pitch of 20 μm to 500 μm, and a depth of 20 μm to 100 μm.

Then, pellets of low density polyethylene (density=0.92, manufactured by Sigma-Aldrich Co.) were melted and kneaded at 180° C. and made into a plate. The plate was heated to 160° C. and pressed at 30 kg/cm² by a hot press, whereby an unstretched film of low density polyethylene (40 μm in thickness) was prepared.

In preparing Samples 5 and 10, 5.0 wt % of titanium oxide was added as a filler in melting and kneading the pellets. In preparing Sample 6, 3.0 wt % of carbon fiber was added as a filler in melting and kneading the pellets as done in the foregoing two samples.

Young's modulus measuring method as described below was carried out to determine the Young's modulus when an unstretched film of low density polyethylene to be used in preparing Samples 1 to 14 was elongated by 1%.

[Young's Modulus Measuring Method]

A strip of a test piece measuring 10 mm (width)×100 nm (length)×30 μm (thickness) was prepared and was subjected to a tensile test using an Instron universal testing machine (Instron 1175 Model, manufactured by Instron Corporation) at a stretching rate of 20 mm/min to give a value (load at 1% elongation/test piece section) which is a value of Young' modulus at 1% elongation.

The obtained film sheet was superimposed on plain paper (product of Minolta Co., Ltd., EPA4 paper). Then an impressing block produced beforehand was laid on the sheet in such a manner to bring the surface of the block having the continuous grooves into contact with the sheet. Thereafter the sheet was heated to 150° C. and pressed at 10 kg/cm² by a hot press (product of Imoto Mfg. Co., Ltd.) for 30 minutes, whereby a sample with an irregular surface was produced.

A width A (μm) of ridges of irregular surface of the obtained sheet, a width B (μm) of concavities thereof and a depth C (μm) of concavities (height of ridges) thereof (see FIG. 1(B)) were measured by a laser displacement meter of non-contact type. Table 1 shows the values A, B and C and Young's modulus of Samples 1 to 14.

TABLE 1

| | | Y.M. | A | B | C |
|---|---|---|---|---|---|
| | material | (GPa) | (μm) | (μm) | (μm) |
| sample 1 | LDPE | 0.12 | 5 | 95 | 45 |
| sample 2 | LDPE | 0.12 | 5 | 45 | 45 |
| sample 3 | LDPE | 0.12 | 5 | 25 | 45 |
| sample 4 | LDPE | 0.12 | 5 | 45 | 25 |
| sample 5 | LDPE | 0.45 | 5 | 95 | 45 |
| sample 6 | LDPE | 0.55 | 5 | 95 | 45 |
| sample 7 | LDPE | 0.12 | 10 | 90 | 45 |
| sample 8 | LDPE | 0.12 | 10 | 40 | 45 |
| sample 9 | LDPE | 0.12 | 10 | 90 | 25 |
| sample 10 | LDPE | 0.48 | 10 | 90 | 45 |
| sample 11 | LDPE | 0.12 | 15 | 85 | 45 |
| sample 12 | LDPE | 0.12 | 20 | 80 | 45 |
| sample 13 | LDPE | 0.12 | 40 | 60 | 45 |
| sample 14 | LDPE | 0.12 | 80 | 160 | 45 |

LDPE: Low Density Polyethylene
Y.M.: Young's Modulus

(Sample 15 to Sample 19)

Sample 15 to Sample 19 are image receiving sheets of a non-fixing type formed of high density polyethylene.

First, impressing blocks for forming an irregular surface on the image receiving sheet were produced. Each of the impressing block was a silicon wafer on which a plurality of continuous grooves in a regular arrangement were formed by dicer processing. A plurality of impressing blocks were produced for each sample. Each impressing block had a plurality of continuous grooves which measured 5 μm to 100 μm at a width, 20 μm to 500 μm at a pitch and 20 μm to 100 μm at a depth.

Then, pellets of high density polyethylene (density=0.95, manufactured by Sigma-Aldrich Co.) were melted and kneaded at 180° C. and made into a plate. The plate was heated to 170° C. and pressed at 30 kg/cm² by a hot press, whereby an unstretched film of high density polyethylene (40 μm in thickness) was prepared.

Young's modulus was measured according to Young's modulus measuring method as described above to determine the modulus when an unstretched film of high density polyethylene to be used in preparing Samples 15 to 19 was elongated by 1%.

The obtained film sheet was superimposed on plain paper (product of Minolta Co., Ltd., EPA4 paper). Then the impressing block was laid on the sheet in a manner to bring the surface of the block having the continuous grooves into contact with the sheet. Thereafter the sheet was heated to 160° C. and pressed at 10 kg/cm² by a hot press (product of Imoto Mfg. Co., Ltd.) for 30 minutes, whereby a sample with an irregular surface was produced.

A width A (μm) of ridges of irregular surface of the obtained sheet, a width B (μm) of concavities thereof, and a depth C (μm) of concavities (height of ridges) thereof (see FIG. 1(B)) were measured by a laser displacement meter of non-contact type. Table 2 shows the values A, B and C and Young's modulus of Samples 15 to 19.

TABLE 2

| | | Y.M. | A | B | C |
|---|---|---|---|---|---|
| | material | (GPa) | (μm) | (μm) | (μm) |
| sample 15 | HDPE | 0.97 | 5 | 95 | 45 |
| sample 16 | HDPE | 0.97 | 10 | 90 | 45 |
| sample 17 | HDPE | 0.97 | 20 | 80 | 45 |
| sample 18 | HDPE | 0.97 | 40 | 60 | 25 |
| sample 19 | HDPE | 0.97 | 80 | 160 | 45 |

HDPE: High Density Polyethylene
Y.M.: Young's Modulus

(Sample 20 to Sample 22)

Sample 20 to Sample 22 are image receiving sheets of a non-fixing type formed of polypropylene.

First, impressing blocks for forming an irregular surface of the image receiving sheet were produced. Each of the impressing block was a silicon wafer on which a plurality of continuous grooves in a regular arrangement were formed by dicer processing. A plurality of impressing blocks were produced for each sample. Each impressing block had a plurality of continuous grooves which measured 5 μm to 100 μm in width, 20 μm to 500 μm in pitch and 20 μm to 100 μm in depth.

Then, pellets of polypropylene (density=0.91, manufactured by Sigma-Aldrich Co.) were melted and kneaded at 200° C. and made into a plate. The plate was heated to 180° C. and pressed at 30 kg/cm² by a hot press, whereby an unstretched film of polypropylene (40 μm in thickness) was prepared.

According to Young's modulus measuring method as described above, the Young's modulus was measured at 1% elongation of an unstretched film of polypropylene to be used in preparing Samples 20 to 22.

The obtained film sheet was superimposed on plain paper (product of Minolta Co., Ltd., EPA4 paper). Then the impressing block was laid on the sheet in a manner to bring the surface of the block having the continuous grooves into contact with the sheet. Thereafter the sheet was heated to 180° C. and pressed at 10 kg/cm² by a hot press (product of Imoto Mfg. Co., Ltd.) for 30 minutes, whereby a sample with an irregular surface was produced.

A width A (μm) of ridges of irregular surface of the obtained sheet, a width B (μm) of concavities thereof, and a depth C (μm) of concavities (height of ridges) thereof (see FIG. 1(B)) were measured by a laser displacement meter of non-contact type. Table 3 shows the values A, B and C and Young's modulus of Samples 20 to 22.

TABLE 3

| | | Y.M. | A | B | C |
|---|---|---|---|---|---|
| | material | (GPa) | (μm) | (μm) | (μm) |
| sample 20 | PP | 1.7 | 2 | 48 | 45 |
| sample 21 | PP | 1.7 | 5 | 45 | 45 |
| sample 22 | PP | 1.7 | 20 | 80 | 45 |

PP: Polypropylene
Y.M.: Young's Modulus

(Sample 23 to Sample 25)

Sample 23 to Sample 25 are image receiving sheets of a non-fixing type formed of biodegradable resin.

First, impressing blocks for forming an irregular surface of the image receiving sheet were produced. Each of the impressing blocks was a silicon wafer on which a plurality of continuous grooves in a regular arrangement were formed by dicer processing. A plurality of impressing blocks were prepared for each sample and each had a plurality of continuous grooves which had a width of 5 μm to 100 μm, a pitch of 20 μm to 500 μm, and a depth of 20 μm to 100 μm.

Then, a biodegradable polymer (Celgreen: PHB05, product of Dicel Chemical Industries, Ltd.) was melted and kneaded at 140° C. and made into a plate. The plate was heated to 150° C. and pressed at 30 kg/cm² by a hot press, whereby an unstretched film of biodegradable polymer (40 μm in thickness) was prepared.

In preparing Sample 25, 2.0 wt % of calcium carbonate was added as a filler in heating and kneading the polymer.

Young's modulus at 1% elongation of an unstretched film of biodegradable polymer to be used for Samples 23 to 25 was measured according to the above-described Young's modulus measuring method.

The obtained film sheet was superimposed on plain paper (product of Minolta Co., Ltd., EPA4 paper). Then the impressing block produced beforehand was laid on the sheet in a manner to bring the surface of the impressing block having the continuous grooves into contact with the sheet. Thereafter the sheet was heated to 150° C. and pressed at 10 kg/cm² by a hot press (product of Imoto Mfg. Co., Ltd.) for 30 minutes, whereby a sample with an irregular surface was produced.

A width A (μm) of ridges of irregular surface of the sheet, a width B (μm) of concavities thereof, and a depth C (μm) of concavities (height of ridges) thereof (see FIG. 1(B)) were measured by a laser displacement meter of non-contact type. Table 4 shows the values A, B and C and Young's modulus of Samples 23 to 25.

TABLE 4

| | | Y.M. | A | B | C |
|---|---|---|---|---|---|
| | material | (GPa) | (μm) | (μm) | (μm) |
| sample 23 | PHB05 | 0.32 | 5 | 45 | 45 |
| sample 24 | PHB05 | 0.32 | 15 | 35 | 45 |
| sample 25 | PHB05 | 0.86 | 20 | 80 | 45 |

Y.M.: Young's Modulus

(Sample 26 to Sample 34)

Sample 26 to Sample 34 are image receiving sheets of a non-fixing type formed of a curable resin (epoxy resin).

Impressing blocks for forming an irregular surface of the image receiving sheet were produced. First, mother dies for forming a plurality of continuous grooves in a regular arrangement were produced on a metallic plate by dicer processing. A plurality of mother dies were provided with continuous grooves which had a width of 5 μm to 100 μm, a pitch of 20 μm to 500 μm and a depth of 20 μm to 100 μm. Impressing blocks for forming continuous grooves were produced by impressing the pattern of the mother dies on a silicone resin (TSE-350/CE-62, product of GE Toshiba Silicones).

An epoxy resin (product of Epoch Co., Ltd.) was mixed with a curing agent in a mixing ratio of 2/1 (epoxy resin/curing agent) and stirred. In preparing Sample 34, 2.0 wt % of glass fiber was added as the filler in stirring the mixture of epoxy resin and curing agent.

The uniformly stirred mixture of epoxy resin and curing agent or the uniformly stirred mixture of epoxy resin, curing agent and filler was applied to RC paper (Mitsubishi Paper Mills, Ltd.) of A4 size by a bar coater. The impressing block made of silicone resin was superimposed on the sheet. Thereafter the sheet was left to stand as pressed at 60° C. and 10 kg/cm² for 24 hours, whereby a sample made of epoxy resin having an irregular surface was obtained.

Young's modulus at 1% elongation of the sample of epoxy resin having the irregular surface was measured according to the above-described Young's modulus measuring method.

A width A (μm) of ridges of irregular surface of the sheet, a width B (μm) of concavities thereof, and a depth C (μm) of concavities (height of ridges) thereof (see FIG. 1(B)) were measured by a laser displacement meter of non-contact type. Table 5 shows the values A, B and C and Young's modulus of each of Samples 26 to 34.

TABLE 5

| | | Y.M. | A | B | C |
|---|---|---|---|---|---|
| | material | (GPa) | (μm) | (μm) | (μm) |
| sample 26 | epoxy resin | 1.9 | 5 | 45 | 45 |
| sample 27 | epoxy resin | 1.9 | 5 | 95 | 45 |
| sample 28 | epoxy resin | 1.9 | 10 | 40 | 45 |
| sample 29 | epoxy resin | 1.9 | 10 | 90 | 45 |
| sample 30 | epoxy resin | 1.9 | 20 | 80 | 45 |
| sample 31 | epoxy resin | 1.9 | 40 | 60 | 45 |
| sample 32 | epoxy resin | 1.9 | 80 | 160 | 45 |
| sample 33 | epoxy resin | 0.13 | 15 | 85 | 45 |
| sample 34 | epoxy resin | 0.57 | 1 5 | 85 | 45 |

Y.M.: Young's Modulus

Using each of Samples 1 to 34, non-fixed images were formed on the irregular surface of each sample by the aforesaid image forming method, and the usefulness of each sample was evaluated by the following evaluation method (smear ratings).

[Evaluation]

The method of evaluating the degree of smear is as follows.

Plain paper (Minolta EP paper) was allowed to reciprocatingly slide over 100% solid printing portion of the sample sheet under a pressure of 100 g/cm² at 5 strokes. In this operation, the degree of smear adhering to the EP paper was measured by a spectrocalorimeter (product of Minolta Co., Ltd; CM-3700d) and was expressed in luminous reflectance (Y value). The smear value was calculated by the following equation:

Smear value=1−(Y value of plain paper after test/Y value of plain paper before test)

When the smear value was in the range of 0 to 0.1, the sample was usable (indicated by ∘), whereas when it was more than 0.1, the sample was not usable (indicated by X).

The evaluation results are shown in Table 6.

TABLE 6

| | Y.M. | A | Y.M. × A | Smear |
|---|---|---|---|---|
| | (GPa) | (μm) | (μm) | Evaluation |
| sample 1 | 0.12 | 5 | 0.6 | x |
| sample 2 | 0.12 | 5 | 0.6 | x |
| sample 3 | 0.12 | 5 | 0.6 | x |
| sample 4 | 0.12 | 5 | 0.6 | x |
| sample 5 | 0.45 | 5 | 2.25 | ∘ |
| sample 6 | 0.55 | 5 | 2.75 | ∘ |
| sample 7 | 0.12 | 10 | 1.2 | x |
| sample 8 | 0.12 | 10 | 1.2 | x |
| sample 9 | 0.12 | 10 | 1.2 | x |
| sample 10 | 0.48 | 10 | 4.8 | ∘ |
| sample 11 | 0.12 | 15 | 1.8 | x |
| sample 12 | 0.12 | 20 | 2.4 | ∘ |
| sample 13 | 0.12 | 40 | 4.8 | ∘ |
| sample 14 | 0.12 | 80 | 9.6 | ∘ |
| sample 15 | 0.97 | 5 | 4.85 | ∘ |
| sample 16 | 0.97 | 10 | 9.7 | ∘ |
| sample 17 | 0.97 | 20 | 19.4 | ∘ |
| sample 18 | 0.97 | 40 | 38.8 | ∘ |
| sample 19 | 0.97 | 80 | 77.6 | ∘ |
| sample 20 | 1.7 | 2 | 3.4 | ∘ |
| sample 21 | 1.7 | 5 | 8.5 | ∘ |
| sample 22 | 1.7 | 20 | 34.0 | ∘ |
| sample 23 | 0.32 | 5 | 1.6 | x |
| sample 24 | 0.32 | 15 | 4.8 | ∘ |
| sample 25 | 0.86 | 20 | 17.2 | ∘ |
| sample 26 | 1.9 | 5 | 9.5 | ∘ |
| sample 27 | 1.9 | 5 | 9.5 | ∘ |
| sample 28 | 1.9 | 10 | 19.0 | ∘ |
| sample 29 | 1.9 | 10 | 19.0 | ∘ |
| sample 30 | 1.9 | 20 | 38.0 | ∘ |
| sample 31 | 1.9 | 40 | 76.0 | ∘ |
| sample 32 | 1.9 | 80 | 152.0 | ∘ |
| sample 33 | 0.13 | 15 | 1.95 | x |
| sample 34 | 0.57 | 15 | 8.55 | ∘ |

Y.M.: Young's Modulus

In consideration of Young's modulus E[GPa], a width A of ridges [μm] and the results of evaluation of smear degree for each sample, the sample assessed as unusable in the results of smear evaluation was a sheet in which a product obtained by multiplying Young's modulus E[GPa] and a width of ridges [μm] is 2 or less, that is to say, E·A<2[Gpa·μm]. In other words, a preferred image receiving sheet for forming a non-fixed image is one which can fulfill the relationship of Young's modulus E X the width A of ridges ≧2[GPa·μm].

(2) Third Type Image Receiving Sheet

The third type image receiving sheet has the same basic structure as above except that the ridges are reinforced with a reinforcing portion for keeping the posture of ridges (for maintaining the posture of ridges in which the ridges are unlikely to fall or buckle)

If the depth of concavities in the form of continuous grooves (height of ridges) is too small, the toner adhering to the concavities tends to peel off, whereas if the depth is too large, the toner is difficult to adhere to the concavities in forming images. In view of this tendency, a suitable depth is about 30 μm to about 150 μm.

The reinforcing portion may be formed continuously or intermittently in the lengthwise direction of ridges.

Typical examples of the reinforcing portion are those of the type (1) and the type (2) as described below.

(1) The reinforcing portion may be at least a lower portion of the ridge adjacent to the bottom portion of the concavity, the lower portion of the ridge being thicker than an upper portion of the ridge.

Such ridges including the reinforcing portions are trapezoidal, triangular, conical like Mt.Fuji, hemielliptical or hemispheric in section. The reinforcing portion may take the form of a half of a symmetrical section shape. In the latter case, the reinforcing portion is formed only on one side of the ridge. The reinforcing portion shows a low effect if the difference of thickness is small between a lower portion of the ridge or a lower end thereof and an upper portion thereof or an upper end thereof. Consequently the lower portion of the ridge is preferably thicker by at least 1.2 times than the upper portion of the ridge.

In any case, the bottom portion of the concavity and the reinforcing portion adjacent thereto form a concavely curved surface to facilitate the removal of the toner from the concavities for reuse of the image receiving sheet.

If the radius of curvature in the concavely curved surface is too small, only a low effect of reinforcement is expected. Therefore, the radius of the curvature is preferably 15 μm or more, more preferably 30 μm or more.

(2) The reinforcing portion may be at least a portion of an upper end portion of the ridge which is thicker than an upper portion of the ridge existing downward of the upper end portion of the ridge.

Such reinforcing portion is preferably in the form of a convexly curved shape in outline such as circular or elliptical shape to prevent the toner, for example, from being engaged in the reinforcing portion.

The reinforcing portion of the type 1 or 2 may be formed continuously or intermittently in the lengthwise direction of the ridge.

Other examples of the reinforcing portion are as follows.

The reinforcing portion may be a portion ascending from the bottom portion of concavity, the ascending portion being formed between neighboring ridges having the concavity therebetween.

While an upper end of the ascending portion may be at the same level as upper ends of the ridges, the upper end of the ascending portion may be at a lower level than the upper ends of the ridges to facilitate removal of toner from the concavities for reuse of image receiving sheet.

At any rate, when the ascending portion is formed, the bottom portion of the concavity and a lower portion of the ridge adjacent thereto may be in the form of a concavely curved surface in outer outline to facilitate removal of toner from the concavities for reuse of the image receiving sheet and to reinforce the ridges of image receiving sheet. Further, the bottom portion of the concavity and a lower portion of the ascending portion adjacent thereto may be in the form of a concavely curved surface in outer outline for the same reason.

For forming any type of the reinforcing portion, thermoplastic resins and/or curable resins which are curable by a specified treatment can be used at least as the material for forming the concavities and the ridges reinforced by the reinforcing portion.

Usable as thermoplastic resins and curable resins are the examples already given concerning the first type image receiving sheet.

The photopolymerization initiator to be used when a photocurable resin is used is as described above.

Materials for forming concavities and ridges may include, for example, biodegradable resins which are degraded on contact with water or bacteria when buried in the soil.

Examples of useful biodegradable resins are chemosynthetic resins, microorganism-producing resins and natural resins. Among them, it is preferred to use natural resins having a chemical structure like that of the raw material for paper.

Materials for forming concavities and ridges may include, for example, polymers which can be disolved in a solvent and solidified on vaporization of the solvent.

Examples of such polymers solidifiable on vaporization of the solvent are epoxy resins, acrylic resins, urethane resins, urethane-urea resins, cellulose derivatives and the like. These polymers can be used either alone or in combination. A curing agent may be added to these resins.

In any case, materials for forming concavities and ridges may include, for example, materials containing at least one kind of fillers. The addition of fillers to the polymer resin can upgrade the properties of the polymer resin due to the filler. The filler is incorporated into the material for forming concavities and ridges preferably in an amount of about 0.5 wt. % to about 50 wt. %. The filler may be substantially uniformly dispersed in the material for forming concavities and ridges or may be allowed to exist locally close to the surface of ridges and concavities.

Useful fillers include the examples given hereinbefore concerning the first type image receiving sheet.

At any rate, the filler may be subjected to surface-modifying treatment such as silane-coupling treatment, titanate-coupling treatment or the like to increase the affinity for polymers.

At least one kind of additives such as antistatic agents, stabilizers and surface tension adjusting agents and the like may be added to the polymer or like materials for forming concavities and ridges. The additives or like materials may be, for example, dispersed uniformly in the material. The antistatic agents, stabilizers and surface tension adjusting agents may be applied to the irregular surface after formation of the irregular surface from the material such as polymers.

The image receiving sheet may comprise a sheet substrate layer and a layer formed thereon from the material for forming the concavities and ridges.

The sheet substrate layer may be, for example, papers or films. Useful papers are, for example, wood-free plain paper, regenerated paper, recycled paper and RC paper coated with polyethylene or like resins, the paper having a basis weight of about 25 g/m² to about 250 g/m². Useful films are, for example, polyethylene films, polypropylene films, polyethylene terephthalate films, etc.

A margin portion free of concavities and ridges may be formed at least at a portion of a peripheral area of the sheet surface including an irregular surface. The image receiving sheet having such margin portion belongs to the second type image receiving sheet of the invention.

If such margin portion is formed on the image receiving sheet, the image receiving sheet can be handled by use of the margin portion without contact with the irregular surface. Thereby damage to the ridges can be suppressed to allow more suitable formation of images. Further it is possible to prevent the damage of toner image in the image receiving sheet having the toner image formed thereon and to inhibit the adhesion of toner to our fingers.

The margin portion may be preferably formed at least in a region wherein a sheet-feeding device exerts a strong action on the image receiving sheet when each sheet is pulled out and fed by the sheet-feeding device from the accumulated sheets.

The above-mentioned image receiving sheet can be produced, for example, by the methods described hereinbefore concerning the first type image receiving sheet. In the case of an image receiving sheet having an ascending reinforcing portion in the concavity, a mesh material may be adhered to the sheet substrate. In this case, preferred mesh materials include, for example, those composed of chemosynthetic fibers, semi-chemosynthetic fibers, natural fibers or the like.

Image formation on the third type image receiving sheet can be done by the method and apparatus for forming a non-fixed image on the sheet as described hereinbefore concerning the first type image receiving sheet.

On the third type image receiving sheet, image(s) can be formed such that a toner image is removably retained without being fixed to the sheet as conventionally done. Consequently the toner image can be separated and removed for reuse. Moreover, a toner image can be suitably formed on the image receiving sheet and can be properly retained thereon.

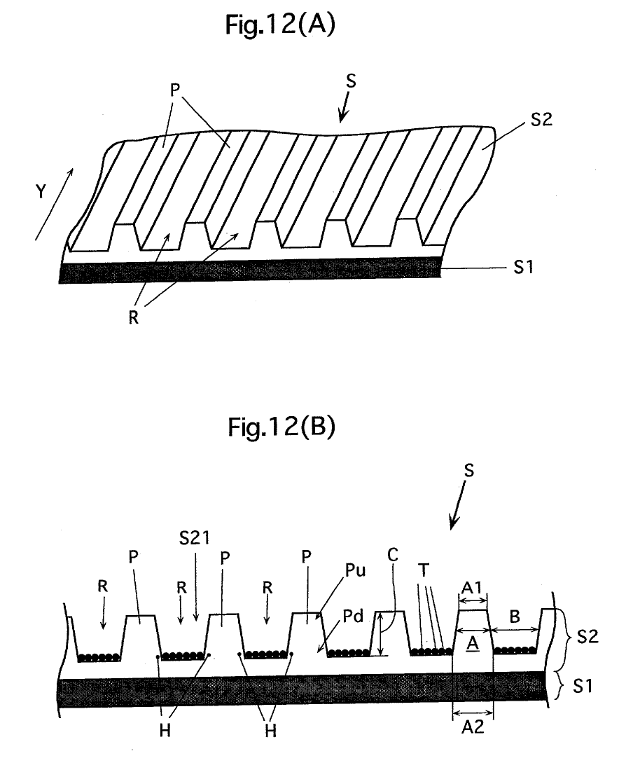

Specific examples of the third type image receiving sheet will be described with reference to FIG. 12(A) to FIG. 16(C).

FIG. 12(A) and FIG. 12(B) are a perspective view showing a portion of an example of the third type image receiving sheet and an enlarged section view of the image receiving sheet, respectively.

The image receiving sheet S comprises a sheet substrate S1 made of paper and an image receiving layer S2 composed of a synthetic resin on one surface of the substrate S1 as shown in FIG. 12(B). The image receiving sheet S is in a white color as a whole. The letter T represents the toner in an enlarge size.

The image receiving layer S2 has continuously grooved concavities R for accommodating the toner T and ridges P for protecting the toner accommodated in the concavities R. In the sheet S, the concavities R and ridges P of the image receiving layer S2 are formed in parallel with a sheet feed direction Y (see FIG. 12(A)). The sheet feed direction Y is a direction in which the sheet is transported in forming a non-fixed image on the image receiving sheet S as described later.

If the depth of the concavity R (height of the ridge) is too small, the toner T adhering to the concavities is apt to peel off, whereas if it is too large, it is difficult to adhere the toner to the concavities R in forming images. Therefore, the height C of the ridge is suitably in the range of about 30 μm to about 150 μm. The range of the height C is the same in other examples of the image receiving sheet described later.

In the ridges P of the image receiving layer S2, a width A2 of lower portion Pd is thicker than a width A1 of upper portion Pu, and the portion providing the thicker wall of the lower portion Pd forms reinforcing portions H to prevent the ridges P from causing deformation such as falling and buckling. However, if the difference of thickness is small between the width A1 of the upper portion Pu and the width A2 of the lower portion Pd, the reinforcing portions H can achieve only a low effect of preventing the deformation of ridge P. Thus, the relationship of A2≧1.2·A1 preferably exists between the width A1 of the upper portion and the width A2 of the lower portion.

In the image receiving sheet S, an average width B of concavities R in the image receiving layer S2 is about 15 μm to about 400 μm; an average width A of ridges P is about 5 μm to about 50 μm; and an average depth C of concavities R (height of the ridge P) is about 30 μm to about 150 μm. The average width A of ridges P is in the range of ½ to 1/50 the average width B of concavities R.

The image receiving sheet S has the concavities R and ridges P uniformly disposed on the image receiving layer S2. The total area occupied by the concavities R in the irregular surface S21 of image receiving layer S2 is greater than the total area occupied by the ridges P. The depth and width of concavities R are greater than the average particle size of the toner and are sufficient to receive a plurality of toner particles.

The illustrated image receiving sheet S is a two-layer laminate sheet comprising a sheet substrate S1 and an image receiving layer S2 formed on the sheet substrate S1. The sheet S may be a laminate sheet composed of more than two layers, or may be a single layer sheet.

The image receiving sheet in this embodiment has a white color although not limited thereto and may have other color corresponding to the color of toner.

Materials for forming the image receiving layer S2 (materials forming the ridges and concavities) are, for example, the above-described thermoplastic resins and/or curable resins which are curable by specified treatment.

Materials for forming the image receiving layer S2 may include, for example, biodegradable resins which are degraded on contact with water or bacteria when buried in the soil.

Materials for forming the image receiving layer S2 may include, for example, polymers which is disolved in a solvent and solidified on vaporization of the solvent.

At any rate, materials for forming the image receiving layer S2 may contain, for example, two or more species of fillers in an amount of about 0.5 wt. % to about 50 wt. %.

The filler may be subjected to surface-modifying treatment such as silane-coupling treatment, titanate-coupling treatment or the like.

At least one kind of additives such as antistatic agents, stabilizers and surface tension adjusting agents and the like may be added to the material for forming the image receiving layer S2. The additives may be applied to the irregular surface after formation of the irregular surface.

The image receiving sheet S may comprise a sheet substrate layer and a layer S2 of the material for forming the concavities and ridges on the sheet substrate layer.

The sheet substrate S1 may be composed of paper having a basis weight of about 25 g/m² to about 250 g/m² or film. Useful films are, for example, polyethylene films, polypropylene films, polyethylene terephthalate films and the like.

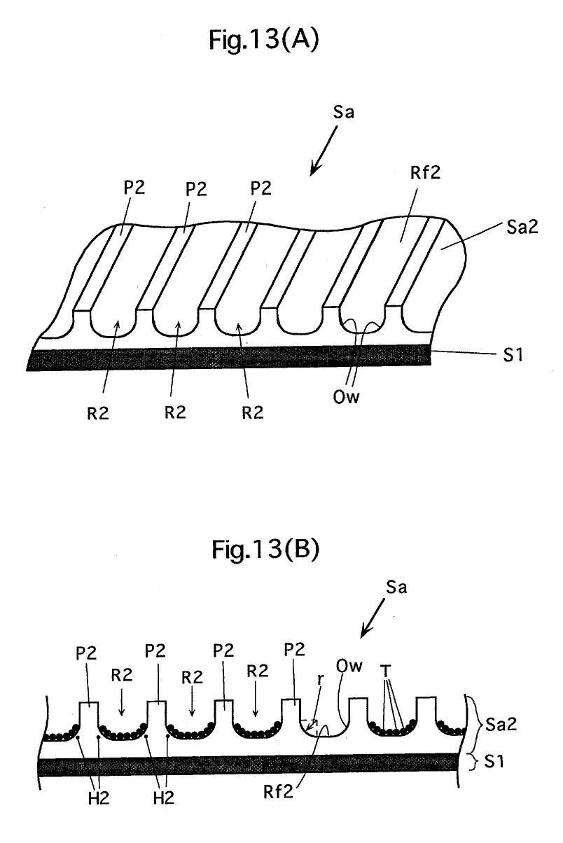

FIG. 13(A) and FIG. 13(B) are a perspective view and an enlarged section view of the image receiving sheet, respectively, showing a portion of a further example of the third type image receiving sheet.

Members and portions shown in FIG. 13(A) and FIG. 13(B) substantially identical in the shape and effect with those of the image receiving sheet S shown in FIG. 12(A) are indicated by like reference numerals in these figures.

As shown in FIG. 13(B), the image receiving sheet Sa has the same basic structure as the image receiving sheet S of FIG. 12(A). That is, it comprises a sheet substrate S1 made of paper and an image receiving layer Sa2 made of synthetic resin on one surface of the sheet substrate S1, and has a white color as a whole.

The image receiving layer Sa2 has concavely curved surfaces Ow formed by the ridges P2 and bottom portions Rf2 of concavities R2 for accommodating the toner T. The concavely curved surface Ow includes a reinforcing portion H2 which serves to prevent the ridge P2 from deforming such as collapsing and buckling as is the case with the ridge P having a lower portion of greater thickness in the image receiving sheet S of FIG. 12(A). However, if the concavely curved surface Ow has a small radius r of curvature, the reinforcing portion can achieve only a low effect. Accordingly the desirable radius r of curvature of concavely curved surface Ow is in the range of preferably r≧15 μm, more preferably r≧25 μm.

When the ridges P2 and the bottom portions Rf2 of concavities R2 form concavely curved surfaces, the toner can be easily removed by means for removing the toner T, as compared with the concavities R of the image receiving sheet S.

The shape of ridges of the image receiving sheet is not limited to the above shapes, and may be, for example, triangular, conical like Mt.Fuji, hemielliptical or hemispheric in sectional shape.

Concavely curved surfaces may be formed by the lower portions of the ridges having the above-mentioned various sectional shapes in combination with the bottom portions of concavities.

The ridges may be formed in the form of a half of symmetrical section (including the two examples of sectional shapes described above). In this case, a reinforcing portion may be formed only on one side of the ridge.

The reinforcing portion may be different in section on the left side and on the right side of the ridge. For example, the right side of the ridge may be hemi-trapezoidal in section while the left side has a sectional shape of concavely curved surface. In this case, the reinforcing portions on the right and left sides achieve different effects.

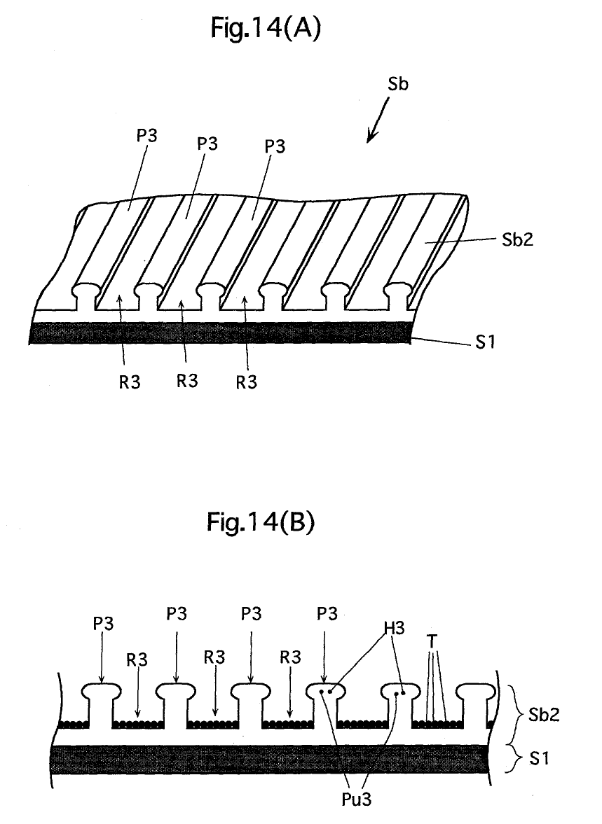

FIG. 14(A) and FIG. 14(B) are a perspective view and an enlarged section view, respectively showing a portion of a still further example of the third type image receiving sheet.

In these figures, like members of the image receiving sheet S shown in FIG. 12(A) are indicated by like reference numerals.

As shown in FIG. 14(B), the image receiving sheet Sb has the same basic structure as the image receiving sheet S of FIG. 12(A). That is, it comprises a sheet substrate S1 made of paper and an image receiving layer Sb2 of made of a synthetic resin on one surface of the sheet substrate S1, and has a white color as a whole.

The image receiving layer Sb2 has concavities R3 for accommodating the toner T and ridges P3 for protecting the toner T accommodated in the concavities R3. Each of the ridges P3 has a reinforcing portion H3 of elliptical section in an upper end Pu3, the reinforcing portion H3 continuously extending in the lengthwise direction of the ridge.

The reinforcing portion H3 is formed in greater thickness than the portions of ridge P3 which do not include the reinforcing portion H3. For this structure, the ridges are unlikely to cause the deformation such as collapsing and buckling.

In the image receiving sheet Sb shown in FIG. 14(a) and FIG. 14(b), the reinforcing portions H3 are continuously formed in the lengthwise direction of ridges P3. However, the reinforcing portions H3 may be intermittently formed insofar as they are sufficiently effective in suppressing the deformation of the ridges.

In the image receiving sheet Sb shown in FIG. 14(A) and FIG. 14(B), each of the reinforcing portions H3 is elliptical in sectional shape although not limited thereto, and is not confined to any sectional shape insofar as the reinforcing portion H3 is greater in thickness than the width of the ridge P3 having a circular section or other section. However, the external surface of the reinforcing portion H3 is preferably rounded to prevent the toner from being engaged in the reinforcing portion H3.

In the image receiving sheet Sb, the reinforcing portions H3 are formed on the upper ends Pu3 of ridges P3 although not limited thereto, and may be formed at a lower level than the upper ends Pu3 of ridges P3.

When the lower level portion of ridge P3 has a reinforcing portion H3 in the image receiving sheet Sb, the portion H3 may be greater in thickness than the upper portion of the ridge P3, or may form a concavely curved surface together with the bottom portion of concavity.

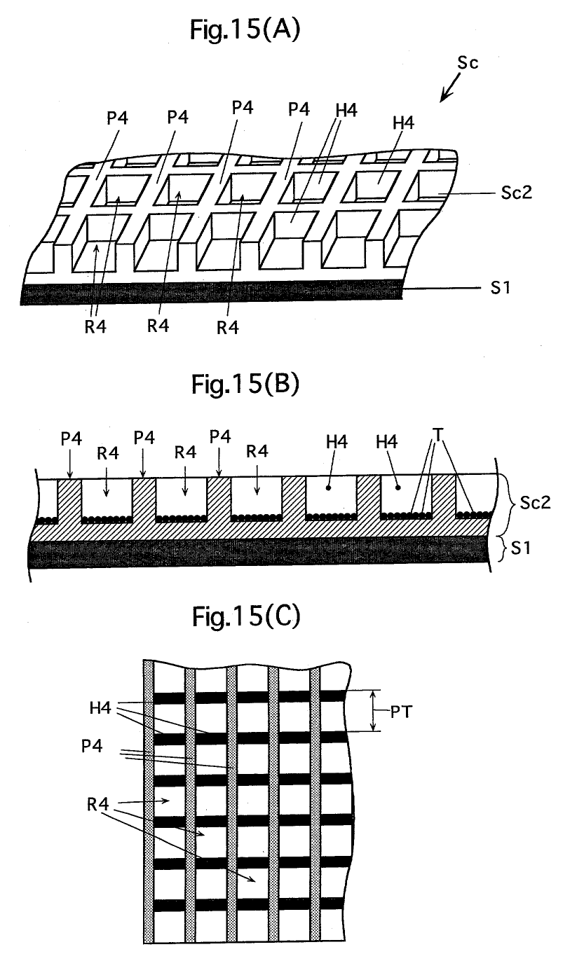

FIG. 15(A), FIG. 15(B) and FIG. 15(C) are a perspective view, an enlarged section view and a plan view, respectively showing a portion of an additional example of the third type image receiving sheet.

Like members substantially identical in shape and effect with those of the image receiving sheet S of FIG. 12(A) are indicated by like reference numerals.

As shown in FIG. 15(B), the image receiving sheet Sc has the same basic structure as the image receiving sheet S of FIG. 12(A). That is, it comprises a sheet substrate S1 made of paper and an image receiving layer Sc2 made of a synthetic resin on one surface of the sheet substrate S1. The sheet Sc has. a white color as a whole.

The image receiving sheet Sc has concavities R4 for accommodating the toner T, ridges P4 for protecting the toner T accommodated in the concavities R4, and reinforcing portions H4 formed with a pitch PT and formed in a direction perpendicular to ridges P4 and ascending in the concavities R4 (see FIG. 15(C)).

In FIGS. 15(A) to FIG. 15(C), the reinforcing portions H4 are formed such that neighboring reinforcing portions are arranged straight. Optionally the reinforcing portions H4 may be partly or entirely formed in different positions in each concavity R4.

The ridges P4 have an upper portion and a lower portion which are identical in width with each other. The reinforcing portion H4 connects together two neighboring ridges P4 to prevent the ridges P4 from deformation such as falling and buckling.

The reinforcing portion H4 is formed integrally with the ridges P4 and has a rectangular section and the same height as the ridges P4.

The reinforcing portion H4 may have a lower height than the ridges P4 if the deformation of ridges P4 is sufficiently prevented.

The reinforcing portion H4 extends in a direction perpendicular to the ridges P4. Optionally it may extend in a direction diagonally crossing the ridges P4.

When the reinforcing portion H4 is formed in the concavity R4, preferably the bottom portion of the concavity and the bottom portion of the ridge(s) forms a concavely curved surface. Also preferable is a concavely curved surface composed of the bottom portion of the concavity and the bottom portion of the reinforcing portion.

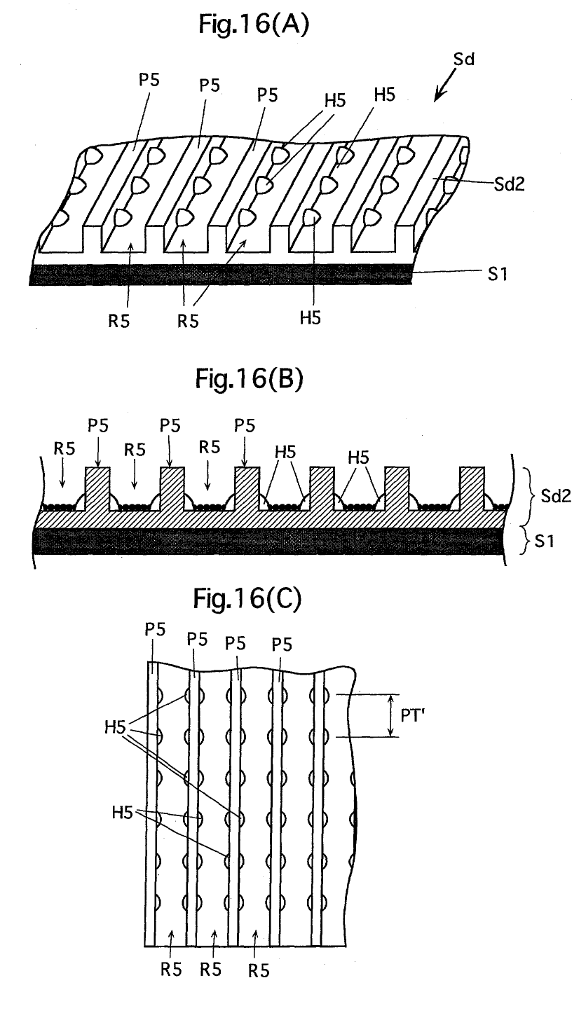

FIG. 16(A), FIG. 16(B) and FIG. 16(C) are a perspective view, an enlarged section view and a plan view, respectively showing a portion of another example of the third type image receiving sheet.

Like members substantially identical in shape and effect with those of the image receiving sheet S of FIG. 12(A) are indicated by like reference numerals.

As shown in FIG. 16(B), the image receiving sheet Sd has the same basic structure as the image receiving sheet S of FIG. 12(A). That is, it comprises a sheet substrate S1 made of paper and an image receiving layer Sd2 of a synthetic resin on one surface of the sheet substrate S1, and has a white color as a whole.

The image receiving sheet Sd has concavities R5 for accommodating the toner T, ridges P5 for protecting the toner T accommodated in the concavities R5, and reinforcing portions H5 of hemispheric sectional shape formed in a lower portion of each of the ridges P5 as separated from each other by the ridge P5.

The ridges PS pass through the center of the reinforcing portions H5 which are intermittently arranged with a pitch PT′ (see FIG. 16(C)).

The reinforcing portions H5 of the image receiving sheet Sd have a hemispheric sectional shape although not limited thereto and can be any shape insofar as the fall of ridges 5 is prevented. Useful shapes include, for example, shapes of rectangular paralellopiped, square cone and the like.

In FIG. 16(A) to FIG. 16(C), reinforcing portions for reinforcing different ridges are aligned together in a direction perpendicular to the lengthwise direction of ridges. The alignment of the reinforcing portions is not limited thereto insofar as the reinforcing portions so aligned can satisfactorily prevent the deformation of ridges.

Images can be formed on the image receiving sheet having reinforcing portions by, e.g., the image forming apparatus shown in FIG. 11.

The toner constituting the toner image formed on the image receiving sheet S is fitted in the concavities R of the irregular surface S21 of the image receiving sheet and is protected by the ridges P of the irregular surface. The toner image is formed on the image receiving sheet by merely adhering the toner to the image receiving sheet without being fixed thereto by heating as done in conventional image forming methods. Nevertheless the toner image so formed can be retained in the desired state unless an extraordinary external force is exerted on the image receiving sheet. When looking at toner images on the image receiving sheet, or storing or merely moving the image receiving sheet, the image receiving sheets may be brought into contact with each other, or our finger may slightly touch the image receiving sheet. Such slight external force would be unlikely to cause undesirable incidents such as marked disturbance of toner images and adhesion of the toner to the rear side of overlaid image receiving sheet.

Moreover, merely the toner is removably adhered to the image receiving sheet and can be separated and removed therefrom so that the removed toner and the image receiving sheet with the toner removed can be reused.

Experiments were carried out for forming images on the image receiving sheet as described in the following Experiment Examples.

Eight kinds of image receiving sheets and one kind of comparative image receiving sheet were produced as samples for use in the experiments.

### EXAMPLE 1 FOR COMPARISON

### Image Receiving Sheet Without a Reinforcing Portion

An impressing block was produced by forming continuous linear grooves of 20 μm wide, 100 μm in pitch and 50 μm deep on a silicon wafer by dicer processing. A film of low density polyethylene (40 μm in thickness) was superimposed on plain paper to give a sheet. Then the impressing block was laid on the film of the sheet. Thereafter the sheet was heated and pressed by a hot press (105° C., 10 kg/cm²), whereby an image receiving sheet having continuous linear grooves formed thereon were produced.

### EXPERIMENTAL EXAMPLE 1

### Image Receiving Sheet Having Ridges of Trapezoidal Section

Continuous linear grooves of trapezoidal section having a opening portion of 30 μm width, a bottom portion of 10 μm width, and a depth of 50 μm with a pitch of 100 μm were formed on a silicone wafer by dicer processing, whereby an impressing block was produced.

A film of low density polyethylene (40 μm in thickness) was superimposed on plain paper to give a sheet. The impressing block was laid on the film of the sheet. Thereafter the sheet was heated and pressed by a hot press (150° C., 10 kg/cm²), whereby an image receiving sheet having continuous linear grooves of trapezoidal section on the surface was produced.

### EXPERIMENTAL EXAMPLE 2

### Image Receiving Sheet Having Concavely Curved Surfaces Comprised of Lower Portions of Ridges and Concavities Adjacent Thereto

Continuous linear grooves having a 80 μm width and a 40 μm depth were formed with a pitch of 100 μm on the surface of a metal plate by etching, giving a mother die. An impressing block was produced by impressing the pattern of mother die on silicone rubber (TSE 350/CE62, product of GE Toshiba Silicones). A film of low density polyethylene (40 μm in thickness) was superimposed on plain paper to give a sheet. The impressing block was laid on the sheet. Thereafter the sheet was heated and pressed by a hot press (150° C., 10 kg/cm²), thereby producing an image receiving sheet having continuous linear grooves with a bottom portion having a curved surface of 40 μm in radius.

### EXPERIMENTAL EXAMPLE 3

### Image Receiving Sheet Having Reinforcing Portions of Elliptical Section in the Upper Ends of Ridges

Continuous linear grooves having a 20 μm width and a 50 μm depth were formed with a pitch of 100 μm on a silicone wafer by dicer processing, whereby an impressing block was produced. A film of low density polyethylene (40 μm) was superimposed on plain paper to give a sheet. The impressing block was laid on the sheet. Thereafter the sheet was heated and pressed by a hot press (150° C., 10 kg/cm²), whereby an image receiving sheet having continuous linear grooves on the surface was produced. The upper ends of ridges aligned in a linear form were coated with an epoxy resin (viscosity 1000 mPa·s) by a roll coater known per se to shape the upper ends of ridges into an elliptical section, and were dried to form reinforcing portions having an elliptical section in the upper ends of ridges, thereby giving an image receiving sheet having ridges including the reinforcing portions having an elliptical section in the upper ends of ridges, and having continuous linear grooves adjacent thereto.

### EXPERIMENTAL EXAMPLE 4

### Image Receiving Sheet Having Reinforcing Portions in the Form of a Rib

Hemispheric holes 40 μm in diameter and 30 μm in depth were made with a pitch of 100 μm on the surface of metal plate by etching. Continuous grooves of 20 μm in width, 100 μm in pitch and 50 μm in depth which passed through the center of etched holes were made by dicer processing, giving an impressing block.

A film of low density polyethylene (40 μm) was superimposed on plain paper to give a sheet. The impressing block was laid on the film of the sheet. Thereafter the sheet was heated and pressed by a hot press (150° C., 10 kg/cm²), thereby producing an image receiving sheet having ridges with rib-shaped reinforcing portions and continuous linear grooves adjacent thereto.

### EXPERIMENTAL EXAMPLE 5

### Image Receiving Sheet Having Ascending Reinforcing Portions Formed in the Concavities

Continuous linear grooves having a 20 μm width and a 50 μm depth were formed with a pitch of 100 μm on a silicone wafer by dicer processing, and linear grooves having a 20 μm width and a 50 μm depth which extended in a direction perpendicular to aforesaid grooves were formed with a pitch of 100 μm on the silicone wafer by dicer processing, whereby an impressing block was produced.

A film of low density polyethylene (40 μm) was superimposed on plain paper to give a sheet. The impressing block was laid on the film of the sheet. Thereafter the sheet was heated and pressed by a hot press (150° C., 10 kg/cm²), whereby an image receiving sheet having ridges on the surface and ascending reinforcing portions perpendicular to the ridges was produced.

### EXPERIMENTAL EXAMPLE 6

### Image Receiving Sheet Having Ascending Reinforcing Portions Formed in the Concavities

Continuous linear grooves having a 80 μm width and a 50 μm depth were formed with a pitch of 100 μm on the surface of metal plate by etching, and linear grooves having a 80 μm width and a 50 μm depth which extended in a direction perpendicular to aforesaid grooves were also formed with a pitch of 100 μm by dicer processing, whereby a mother die was produced. An impressing block was produced by impressing the pattern of mother die on silicone rubber (TSE 350/CE62, product of GE Toshiba Silicones).

A film of low density polyethylene (40 μm) was superimposed on plain paper to give a sheet. The impressing block was laid on the film of the sheet. Thereafter the sheet was heated and pressed by a hot press (150° C., 10 kg/cm²), thereby producing an image receiving sheet having continuous linear ridges and grooves having ascending reinforcing portions perpendicular to the ridges.

Concavely curved surfaces are each formed by lower portions of ridges and the bottom portions of concavities adjacent thereto and by lower portions of the ascending portions and the bottom portions of concavities adjacent thereto, respectively.

### EXPERIMENTAL EXAMPLE 7

### Image Receiving Sheet Having Ascending Reinforcing Portions in Concavities

Continuous linear grooves having a 80 μm width and a 50 μm depth were formed with a pitch of 100 μm on the surface of metal plate by etching, and linear grooves having a 480 μm width and a 50 μm depth which extended in a direction perpendicular to aforesaid grooves were formed with a pitch of 100 μm by dicer processing, whereby a mother die was produced.

An impressing block was produced by impressing the pattern of mother die on silicone rubber (TSE 350/CE62, product of GE Toshiba Silicones).

A film of low density polyethylene (40 μm) was superimposed on plain paper to give a sheet. The impressing block was laid on the film of the sheet. Thereafter the sheet was heated and pressed by a hot press (150° C., 10 kg/cm²), thereby producing an image receiving sheet having continuous linear ridges and grooves having ascending reinforcing portions perpendicular to the ridges.

Concavely curved surfaces are each formed by lower portions of ridges and the bottom portions of concavities adjacent thereto and by lower portions of the ascending portions and the bottom portions of concavities adjacent thereto, respectively.

### EXPERIMENTAL EXAMPLE 8

### Image Receiving Sheet Having Ascending Reinforcing Portions in Concavities

Continuous linear grooves having a 80 μm width and a 50 μm depth were formed with a pitch of 100 μm on the surface of metal plate by etching, and linear grooves having a 1980 μm width and a 50 μm depth which extended in a direction perpendicular to aforesaid grooves were also formed with a pitch of 2000 μm by dicer processing, whereby a mother die was produced. An impressing block was produced by impressing the pattern of mother die on silicone rubber (TSE 350/CE62, product of GE Toshiba Silicones).

A film of low density polyethylene (40 μm) was superimposed on plain paper to give a sheet. The impressing block was laid on the film of the sheet. Thereafter the sheet was heated and pressed by a hot press (150° C., 10 kg/cm²), thereby producing an image receiving sheet having continuous linear grooves with ridges on the surface and ascending reinforcing portions perpendicular to the ridges.

Concavely curved surfaces are each formed by lower portions of ridges and the bottom portions of concavities adjacent thereto and by lower portions of the ascending portions and the bottom portions of concavities adjacent thereto, respectively.

These nine samples were evaluated in respect of usability of image receiving sheet by the following evaluation method.

[Evaluation]

[Assessment of Smear Degree]

100% solid printing was output on each sample by the image forming apparatus and plain paper was allowed to reciprocatingly slide over the surface of the sheet at 5 strokes (under a pressure of 50 g/cm²). Thereafter the luminous reflectance (%) of surface of plain paper having slided over the sheet was measured by a spectrocalorimeter (product of Minolta Co., Ltd., CM-3700d).

The smear ratings were calculated by the following equation:

Smear rating=1−(reflectance [%] of plain paper after sliding/reflectance [%] of plain paper before sliding

When the smear rating was in the range of 0 to 0.1, the sample was deemed as usable (indicated by ∘), whereas when it was more than 0.1, the sample was deemed as unusable (indicated by X).

[Cleaning Evaluation]

100% solid printing was output on each sample by the image forming apparatus and the sheet was cleaned for removal of toner by a specific cleaning device. When the images were completely effaced in one cleaning operation, the sample was assessed as good (indicated by ∘). When the images were completely effaced in two cleaning operations, the sample was assessed as moderately good (indicated by ·). When the images were not completely effaced in two cleaning operations, the sample was assessed as unsuitable (indicated by X).

The evaluation results are shown in Table 7.

TABLE 7

| | Reinforcing | | | |
|---|---|---|---|---|
| | Portion | | S.E. | C.E. |
| E. for C. 1 | non | | x | ∘ |
| E. Ex. 1 | T.S. | | ∘ | ∘ |
| E. Ex. 2 | C.C.S | | ∘ | ∘ |
| E. Ex. 3 | E.S. | | ∘ | ∘ |
| E. Ex. 4 | rib type | | ∘ | ∘ |
| | | R.P. Pitch | | |
| E. Ex. 5 | A.R.P. | 100 μm | ∘ | Δ |
| E. Ex. 6 | A.R.P. | 100 μm | ∘ | ∘ |
| E. Ex. 7 | A.R.P. | 500 μm | ∘ | ∘ |
| E. Ex. 8 | A.R.P. | 2000 μm | ∘ | ∘ |

S.E.: Smear Evaluation
C.E.: Cleaning Evaluation
E. for C.: Example for Comparison
E. Ex.: Experimental Example
T.S.: Trapezodial Section
C.C.S.: Concavely Curved Surface
E.S.: Elliptical Section
R.P. Pitch: Reinforcing Portion Pitch
A.R.P.: Ascending Reinforcing Portion

In the evaluation of smear degree, only the image receiving sheet of Example 1 for comparison lacking a reinforcing portion were unable to attain the standard value. This was because the ridges was deformed and the toner existing in the concavities was adhered to the paper due to the lack of reinforcing portion when the sheet was strongly rubbed.

In the evaluation of cleanability, only the image receiving sheet of Experimental Example 5 required two cleaning operations to completely efface the images. The other image receiving sheets were able to completely efface the images in one cleaning operation. The ridges and the ascending reinforcing portions in the sheet of Experimental Example 5 were brought into orthogonal contact with the bottom portions of the concavities. Further, the bottom portions of concavities lacked a concavely curved surface in which case the toner was difficult to scrape off.

What is claimed is:

1. An image receiving sheet for forming a toner image by removably adhering toner thereto, wherein the sheet has an irregular surface including a plurality of concavities in the form of continuous grooves; the concavities are capable of receiving the toner; the toner image can be formed by removably adhering the toner to the concavities; the irregular surface includes ridges for protecting the toner adhering to the concavities; the continuously grooved concavities have a depth (height of ridges) of 20 μm to 150 μm; a condition of E·A≧2 [GPa·μm] can be established wherein E[GPa] represents Young's modulus and A [μm] represents a width of the ridge; and the condition is established when a material for forming the concavities and ridges is elongated by 1%.

2. The image receiving sheet according to claim 1, wherein at least the material for forming the concavities and ridges is a thermoplastic resin and/or a curable resin which is curable by a specified treatment.

3. The image receiving sheet according to claim 1, wherein at least the material for forming the concavities and ridges is a biodegradable resin.

4. The image receiving sheet according to claim 1, wherein at least the material for forming the concavities and ridges contains 0.5 wt % to 50 wt % of a filler.

5. The image receiving sheet according to claim 4, wherein the material for forming the concavities and ridges contains inorganic fine particles as the filler.

6. The image receiving sheet according to claim 4, wherein the material for forming the concavities and ridges contains organic fine particles as the filler.

7. The image receiving sheet according to claim 4, wherein the material for forming the concavities and ridges contains reinforcing fibers as the filler.

8. The image receiving sheet according to claim 4, wherein the material for forming the concavities and ridges contains finely divided and/or finely fibrous cellulose as the filler.

9. The image receiving sheet according to claim 1, wherein a layer formed of the material for forming the concavities and ridges is formed on a sheet substrate layer.

10. The image receiving sheet according to claim 1, wherein at least one portion of a peripheral area on a surface of the sheet including the irregular surface is a margin portion which does not include the concavities and ridges.

11. The image receiving sheet according to claim 10, wherein the margin portion is formed in a region of the image receiving sheet wherein a sheet-feeding device exerts an action on the sheet when the image receiving sheet is pulled out and fed by the sheet-feeding device which can pull out and feed the image receiving sheet from a stack of the accumulated image receiving sheets.

12. An image receiving sheet for forming a toner image by removably adhering toner thereto, wherein the sheet has an irregular surface including a plurality of concavities in the form of continuous grooves; the concavities are capable of receiving the toner; the toner image can be formed by removably adhering the toner to the concavities; the irregular surface includes ridges for protecting the toner adhering to the concavities; and at least one portion of a peripheral area of the sheet surface including the irregular surface is a margin portion which does not include the concavities and ridges.

13. The image receiving sheet according to claim 12, wherein the margin portion is present in a region of the image receiving sheet wherein a sheet-feeding device exerts an action on the sheet when the image receiving sheet is pulled out and fed by the sheet-feeding device which can pull out and feed the image receiving sheet from a stack of the accumulated image receiving sheets

14. An image receiving sheet for forming a toner image by removably adhering toner thereto, wherein the sheet has an irregular surface including a plurality of concavities in the form of continuous grooves; the concavities are capable of receiving the toner; the toner image can be formed by removably adhering the toner to the concavities; the irregular surface includes ridges for protecting the toner adhering to the concavities; and at least one of the ridges is reinforced by a reinforcing portion for retaining a posture of the ridge.

15. The image receiving sheet according to claim 14, wherein the continuously grooved concavities have a depth (height of ridge) of 30 μm to 150 μm.

16. The image receiving sheet according to claim 14, wherein the reinforcing portion is at least a lower portion of the ridge adjacent to a bottom portion of the concavity, the lower portion of the ridge being thicker than an upper portion of the ridge.

17. The image receiving sheet according to claim 16, wherein the bottom portion of concavity and the reinforcing portion adjacent thereto form a concavely curved surface.

18. The image receiving sheet according to claim 14, wherein the reinforcing portion is at least a portion of an upper end portion of the ridge, which is thicker than an upper portion of the ridge existing downward of the upper end portion of the ridge.

19. The image receiving sheet according to claim 14, wherein the reinforcing portion is continuously formed in a lengthwise direction of the ridge.

20. The image receiving sheet according to claim 16, wherein the reinforcing portion is continuously formed in a lengthwise direction of the ridge.

21. The image receiving sheet according to claim 18, wherein the reinforcing portion is continuously formed in a lengthwise direction of the ridge.

22. The image receiving sheet according to claim 14, wherein the reinforcing portion is intermittently formed in a lengthwise direction of the ridge.

23. The image receiving sheet according to claim 14, wherein the reinforcing portion is at least a portion ascending from a bottom portion of the concavity and the ascending portion is formed between the neighboring ridges having the concavity therebwtween.

24. The image receiving sheet according to claim 23, wherein an upper end of the ascending portion is positioned at the same level as upperends of the ridges.

25. The image receiving sheet according to claim 23, wherein an upper end of the ascending portion is positioned at a lower level than upper ends of the ridges.

26. The image receiving sheet according to claim 23, wherein the bottom portion of the concavity and a lower portion of the ridge adjacent thereto form a concavely curved surface.

27. The image receiving sheet according to claim 23, wherein the bottom portion of the concavity and a lower portion of the ascending portion adjacent thereto form a concavely curved surface.

28. The image receiving sheet according to claim 14, wherein at least a material for forming the concavities and ridges reinforced by the reinforcing portions is a thermoplastic resin and/or a curable resin which is curable by a specified treatment.

29. The image receiving sheet according to claim 14, wherein at least a material for forming the concavities and ridges reinforced by the reinforcing portions is a biodegradable resin.

30. The image receiving sheet according to claim 14, wherein a layer formed of a material for forming the concavities and ridges is formed on a sheet substrate.

31. The image receiving sheet according to claim 14, wherein at least one portion of a peripheral area on a surface of the sheet including the irregular surface is a margin portion which does not include the concavities and ridges.

32. The image receiving sheet according to claim 31, wherein the margin portion is present in a region of the image receiving sheet wherein a sheet-feeding device exerts an action on the image receiving sheet when the image receiving sheet is pulled out and fed by the sheet-feeding device which can pull out and feed the image receiving sheet from a stack of the accumulated image receiving sheets.
